(19) United States
(12) Patent Application Publication
(10) Pub. No.: US 2012/0145944 A1
(43) Pub. Date: Jun. 14, 2012

(54) MAGNETIC MATERIAL AND MOTOR OBTAINED USING SAME

(76) Inventors: Matahiro Komuro, Hitachi (JP); Yuichi Satsu, Hitachi (JP); Hiroyuki Suzuki, Hitachi (JP)

(21) Appl. No.: 13/390,738

(22) PCT Filed: Aug. 11, 2010
(86) PCT No.: PCT/JP2010/063612

§ 371 Date: Feb. 16, 2012

(30) Foreign Application Priority Data
Sep. 30, 2009 (JP) 2009-225895

(51) Int. Cl. H01F 1/01

(52) U.S. Cl. 252/62.51 R

(57) ABSTRACT

Disclosed is a magnetic material in which 50% by volume of the magnetic particles are accounted for by the main phase of the magnet, the main phase having a Curie temperature (Curie point) of 200° C. or higher, a saturation magnetic-flux density at around 20° C. of 1.0 T (tesla) or higher, and a coercive force of 10 kOe or higher, the crystal structure of the main phase being stable up to 200° C., and in which phases other than the main phase which are present at the grain boundaries or grain surfaces have stabilized or improved the magnetic properties. This magnetic material comprises two ferromagnetic phases, i.e., a ferromagnetic compound which is composed of fluorine, iron, and one or more rare-earth elements including yttrium and ferromagnetic iron which contains fluorine, carbon, nitrogen, hydrogen, or boron. A fluoride and an oxyfluoride have been formed at some of the boundaries or surfaces of the grains of the ferromagnetic phases.

### TECHNICAL FIELD

The present invention relates to a magnetic material in which an amount of use of heavy rare-earth elements is reduced, and a motor using the magnetic material.

### BACKGROUND ART

Patent Literatures 1 to 5 disclose conventional rare-earth sintered magnets including fluoride compounds or acid fluoride compounds. Further, Patent Literature 6 discloses mixing of impalpable particles of a rare-earth fluoride compound (from 1 to 20 μm) with NdFeB particles. Further, Patent Literatures 7 and 8 describe examples of fluorinating of Sm₂Fe₁₇.

### CITATION LIST

### Patent Literature

Patent Literature 1: JP-A-2003-282312
Patent Literature 2: JP-A-2006-303436
Patent Literature 3: JP-A-2006-303435
Patent Literature 4: JP-A-2006-303434
Patent Literature 5: JP-A-2006-303433
Patent Literature 6: US Patent Application Publication No. 2005/0081959
Patent Literature 7: Magnetic improvement of R₂Fe₁₇ compounds due to the addition of fluorine, Journal of Materials Science Letters, Volume 16, Number 20, 1658-1661
Patent Literature 8: Full-potential linear-muffin-tin-orbital calculations of the magnetic properties of rare-earth-transitional-metal intermetallics. III. Gd2Fe17Z3 (Z═C, N, O, F), Phys. Rev. B 53, 3296-3303 (1996)

### SUMMARY OF INVENTION

### Technical Problem

The above described conventional inventions disclose those obtained by causing an Nd—Fe—B magnetic material and an Sm—Fe material to react with a compound including fluorine, and especially disclose effects of lattice expansion and increase in Curie temperature by introduction of a fluorine atom by causing Sm₂Fe₁₇ to react with fluorine. However, the Curie temperature of the disclosed SmFeF material is as low as 155° C., and a value of magnetization is unknown. An Nd—Fe—B magnet increases in coercive force by using fluoride including a heavy rare-earth element. The above described fluoride does not cause reaction to fluorinate a main phase, but the heavy rare-earth element reacts with or diffuses into the main phase. Such heavy a rare-earth element is expensive, and therefore, there has been the problem of reducing the heavy rare-earth element. Light rare-earth elements which are less expensive than heavy rare-earth elements are Sc, Y and elements of atomic numbers from 57 to 62 inclusive, and some of the elements are used in magnetic materials. An Nd₂Fe₁₄B magnetic material is most produced among iron-based magnets other than oxides, and absolutely needs addition of a heavy rare-earth element in order to ensure heat resistance.

Further, an Sm₂Fe₁₇N magnet cannot be sintered and is generally used as a bond magnet, and therefore, has a disadvantage in respect of performance. R₂Fe₁₇ (R represents an earth element) alloys have a low Curie temperature (Tc), but the compounds into which carbon or nitrogen penetrates make the Curie temperature high, and therefore, are applied to various magnetic circuits. In these interstitial compounds, in order to produce the material, into which a fluorine atom penetrates, in large quantities as a magnet, it is necessary to ensure magnetic properties by increasing a growth ratio with respect to particles of a fluorine-containing ferromagnetic compound which is a matrix phase.

### Solution to Problem

A volume of a main phase of a magnet accounts for 50% of a volume of magnetic particles, the aforesaid main phase has a Curie temperature (Curie point) of 200° C. or higher, a saturation magnetic-flux density at around 20° C. is 1.0 T (tesla) or higher, a coercive force is 10 kOe or higher, the crystal structure of the main phase is stable up to 200° C., and different phases of a grain boundary or a surface other than the main phase have stabilized or improved magnetic properties, whereby a high-performance magnet can be provided.

More specifically, a magnetic material is used, which comprises two ferromagnetic phases, i.e., a ferromagnetic compound which is composed of fluorine, iron, and one or more rare-earth elements including yttrium, and ferromagnetic iron which contains fluorine, carbon, nitrogen, hydrogen or boron, wherein a fluoride and an acid fluoride is formed in part of a boundary or a surface the ferromagnetic phases.

### Advantageous Effects of Invention

It is possible to provide magnetic particles which realize a high coercive force and a high magnetic-flux density by forming, heat-treating and molding a fluorine-containing film on the magnetic particles containing a light rare-earth element and iron, or on iron particles. It is also possible to achieve low iron loss and high induced voltage by applying a formed body formed by packing the particles to a rotor machine, and therefore it can be applied to a magnetic circuit such as various rotor machines and voice coil motors for a hard disk that require a high energy product.

Other objects, features and advantages of the present invention will be apparent from the following description of examples in conjunction with the accompanying drawings.

### BRIEF DESCRIPTION OF DRAWINGS

FIG. 1 is a diagram (1) showing concentration distributions of fluorine (black dot) and nitrogen (white dot) according to the present invention.

FIG. 2 is a diagram (2) showing concentration distributions of fluorine (black dot) and nitrogen (white dot) according to the present invention.

FIG. 3 is a diagram showing distribution in a depth direction of a lattice constant according to the present invention.

FIG. 4 is a diagram of an XRD pattern according to the present invention.

FIG. 5 is a view of a section of a motor according to the present invention.

FIG. 6 is diagrams showing relations of magnetic properties and a main phase volume fraction according to the present invention.

### DESCRIPTION OF EMBODIMENTS

In order to make residual magnetic-flux density of a magnet high, it is necessary to also make saturation magnetic-flux density high. In order to make the saturation magnetic-flux density high and ensure a high coercive force, it is necessary to enhance anisotropy such as magnetocrystalline anisotropy energy of a magnet matrix phase. First, in order to enhance the saturation magnetic-flux density, interstitial elements are arranged in interstitial sites of Fe, and anisotropy or orientation is given to the arrangement, whereby high magnetocrystalline anisotropy and a high magnetic moment are made compatible with each other. In order to enhance the magnetic anisotropy, anisotropy of antiferromagnetic coupling or rare-earth element orbital is used, and a high coercive force is obtained. Further, FeₙFₘ (n and m are positive integers) which is an iron-fluorine binary compound capable of ferromagnetic coupling with a matrix phase is formed as a second phase other than the matrix phase, and thereby, the residual magnetic-flux density is increased.

This uses an effect of increasing a magnetic moment of iron atoms due to arrangement of fluorine in the interstitial sites of iron of a bcc structure. Especially because Fe₃F or Fe₁₆F₂ has an average magnetic moment of 2.5 to 3.0 Bohr magnetons, a high residual magnetic-flux density of 1.5 T or more to less than 2.5 T can be ensured by these compounds and the matrix phase being ferromagnetically coupled with each other.

In order to form such an iron-fluorine binary compound, magnetic particles or the like are provided with a concentration gradient, and iron or a matrix phase having iron as constituent elements and having larger magnetocrystalline anisotropy than the iron-fluorine binary compound are magnetically coupled, whereby a high-performance magnet can be realized. Fluorine concentration in an iron-fluorine binary alloy is 0.1 to 15 at %, and the fluorine concentration in the matrix phase is 5 to 13 at %. Other than these ferromagnetic phases, an acid fluoride and the like containing impurities are formed, and the fluorine concentration in the iron-fluorine binary alloy is lower than that of the matrix phase having high magnetocrystalline anisotropy in average.

This is because fluorine atoms in the iron-fluorine binary alloy easily form a phase containing impurity elements such as acid fluorides in grain boundaries and the like, and in an ordinary mass production process using gas, ions or a solution containing fluorine, respective average fluorine concentrations in the grain boundary, a matrix phase grain and an iron-fluorine binary alloy phase differ from one another. Further, in the particles or a formed body and a sintered body of the above described phase constitution, the fluorine concentration of the outermost surface except for a protection film, and the fluoride concentration of a center portion differ from each other, and a magnet in which a ratio of the iron-fluorine binary alloy is changed is produced by making the fluorine concentration of the surface lower than that of the center portion, whereby the magnetic moment of the iron atoms of a surface layer portion is increased, and the residual magnetic-flux density can be increased. Further, in order to increase a volume fraction of the main phase and the ferromagnetic phase of fluorine-containing iron, an oxygen concentration in the ferromagnetic phase needs to be reduced by formation of fluorides or acid fluorides in the grain boundaries or the particle surfaces. In order to enhance structure stability to a temperature or the like of a ferromagnetic body in which fluorine atoms are arranged in the interstitial site as described above, addition of third elements such as transitional metal elements and heterogeneous invasion elements, addition of conformity enhancing elements for the lattice constant for enhancing conformity with the matrix phase and formation of a grain boundary phase, and formation of an ordered phase as another phase that is not ferromagnetic are cited.

In order to enhance performance of a ferromagnetic material containing fluorine, the volume fraction of a fluorine-containing compound or alloy showing ferromagnetism in magnetic particles or a magnet needs to be increased. The ferromagnetic material containing fluorine uses at least one transitional metal element such as iron or manganese. The ferromagnetic materials are divided into two that are a substitutional type and an interstitial type depending on arrangement of fluorine atoms. Since an ionic radius of a fluorine atom is smaller than the ionic radius of a transitional metal element, an interatomic distance by introduction of fluorine atoms increases and decreases in any case of the substitutional type and the interstitial type, and therefore, local distortion occurs. The distortion accompanying displacement of interatomic position like this influences a wave function of an electron, and various physical properties such as magnetic properties, electric properties, mechanical properties, thermodynamic properties, specific heat, and superconductivity change. When fluorine is introduced into iron in a magnetic material, an iron-iron interatomic distance increases or decreases, and the volume per iron atom increases in average. The volume increase like this influences the wave function around iron atoms, and the magnetic moment of iron increases. As fluorine is introduced into the interstitial site of pure iron, the magnetic moment of the iron increases by about 5% by introduction of 4 at % of fluorine. Fluorine introduction into the interstitial site not only changes the magnetic moment but also magnetocrystalline anisotropic energy since the fluorine introduction generates lattice deformation.

This means an energy difference in the easy magnetization direction and the difficult magnetization direction of iron changes, and uniaxial magnetic anisotropy increases by introduction of fluorine to the interstitial site. In order to use a magnet by containing fluorine in the main phase in the magnet, the following matters need to be satisfied in consideration of the above described case of iron: 1) the volume of the main phase accounts for 50% of the volume of magnetic particles; 2) the Curie temperature (Curie point) of the main phase is 200° C. or higher; 3) the saturation magnetic-flux density of the main phase is 1.0 T (tesla) or higher at around 20° C.; 4) the coercive force is 10 kOe or higher; 5) the crystal structure of the main phase is stable up to 200° C.; and 6) phases other than the main phase are formed on grain boundaries or grain surfaces, and magnetic properties are stabilized and improved. The mode that satisfies all of the aforesaid 1) to 6) will be described hereunder.

When the main phase is of ReₙFeₘFₗ (Re is a rare-earth element, n, m and l are positive integers), in order to make the main phase volume fraction 50% or higher, it is necessary to reduce an oxygen content, and suppress growth of acid fluorides and oxides to the volume of 50% or lower of the entire magnetic particles. Hydrogen reduction, a method of fluorinating magnetic particles after nitriding and carbonizing the magnetic particles, and reducing the magnetic particles with hydrogen gas or the like after fluorinating the magnetic particles are effective. Further, it is also necessary to fluorinate the magnetic particles at a temperature as low as possible in order to suppress decomposition of the main phase, and fluorination at 200 to 500° C. is desirable. Next, in order to raise the Curie temperature of the main phase, the fluorine concentration distribution of the main phase is controlled, and the ratio of the ferromagnetic phase which does not contain fluorine is desirably made 50% or less so that the main phase is not decomposed, and by making the ratio of the ferromagnetic phase 10% or less if possible, the Curie temperature becomes 300° C. or higher. The fluorine concentration in one particle of the main phase containing fluorine is 0.01 at % to 20 at %. An iron-fluorine binary compound having a Curie temperature higher than that of the main phase is formed in a vicinity of the main phase, and ferromagnetic coupling acts between both of them, whereby the Curie temperature of the main phase rises by 10° C. or more. Since iron-fluorine binary compound alone does not show hard magnetic properties, the volume of the iron-fluorine binary compound is made smaller than that of the main phase, and the residual magnetic-flux density and the Curie temperature can be increased by forming the iron-fluorine binary compound while the coercive force is kept.

Next, in order to make the saturation magnetic-flux density at around 20° C. of the main phase 1.0 T (tesla) or higher, it is necessary to suppress growth of fluorides and acid fluorides which have small values of magnetization. If a particle surface is oxidized before fluorination treatment, acid fluorides easily grow, and therefore, the oxides are desirably removed as much as possible. When the oxides grow on the surface as an oxide layer, a thickness of the layer is desirably 1 μm or less. Further, by introduction of fluorine, distances between iron-iron atoms or iron-rare-earth atoms, and rare-earth-rare-earth atoms increase and decrease, and the magnetic moments of iron and rare-earth elements change before and after introduction. Disposition of the fluorine atoms between iron-iron enlarges the distance between iron atoms and increases the magnetic moment of iron, and thereby, magnetization is increased. Accordingly, it is effective to increase a fluorine introduction amount to the main phase more than the fluorine introduction amount to the phases other than the main phase, and the concentration of fluorine which is interstitially disposed is desirably made 0.01 at % to 20 at % in the main phase. In order to increase magnetization of the main phase, Co is added to 0.1 to 20 at % Fe (iron), or fluorine is disposed at the interstitial site with carbon, nitrogen or hydrogen, whereby increase of magnetization by 0.05 T or more can be obtained.

As for the coercive force, it is necessary to increase crystal magnetic anisotropic energy and decrease a location to be a magnetization reversal site, the crystal magnetic anisotropic energy is increased with the concentration of fluorine which is interstitially disposed of 0.001 at % to 30 at %, and it is necessary to decrease an amount of iron which is not magnetically coupled with the main phase which can be a magnetization reversal location. The main phase (matrix phase) and iron or iron-fluorine compound which is within 1 μm via grain boundaries and third phases can be magnetically coupled with each other, but the volume of iron which is away from a main phase interface by more than 1 μm and is not considered to have a crystal orientation relation with the main phase needs to be as small as possible, and is desirably 20% or less with respect to the volume of the main phase, and if the volume of the iron exceeds 20%, it becomes difficult to obtain a coercive force of 10 kOe. Next, in order to stabilize the crystal structure of the main phase, it is effective to prevent oxidization, use a crystal structure stabilizing element and form an Fe—F binary compound.

The main phase has a crystal structure of a rhombohedral crystal, a hexagonal crystal such as a CaCu₅ type structure, a tetragonal crystal such as a ThMn₁₂ type structure, a rhombic crystal or a cubic crystal, or a plurality of structures of these crystals depending on the type of constituent elements and the composition. In order to stabilize the crystal structure of the main phase, it is necessary to restrain the arrangement of constituent elements from easily changing to another arrangement, and for this purpose, the fluorine atom concentration is optimized, the third element which fixes fluorine to the interstitial site is added, the oxygen concentration is reduced, the crystal grain or the particle surface is covered with a fluoride, an acid fluoride, a nitride, a carbide or metal which suppresses oxidation, and nitrogen, carbon or chlorine which is an interstitial element other than fluorine is mixed with fluorine and disposed, whereby a rhombohedral crystal, a hexagonal crystal, a tetragonal crystal, an rhombic crystal or a cubic crystal in which a fluorine atom is penetrated can be stabilized at a temperature of 500° C. to 900° C.

Next, an effective phase as a phase other than the main phase is iron containing iron fluorine or iron carbon of a tetragonal crystal structure or a cubic crystal structure, iron nitrogen binary or a plurality of interstitial elements of these elements, and the aforementioned iron is formed by 5% by ferromagnetic coupling with the main phase, whereby the residual flux density increases by 0.01 T to 0.1 T. Some irons are enhanced in ferromagnetic coupling by having a specific orientation relation with the main phase, and the residual magnetic-flux density is further increased. Fluorides and acid fluorides which grow on the grain boundaries and the particle surfaces contain fluorine and oxygen which have concentrations higher than the main phase, and have the structure of a cubic crystal, a hexagonal crystal, an rhombic crystal and the like. When a plurality of kinds of rare-earth elements are used for the main phase to improve the magnetic properties, the concentration gradient of the rare-earth elements appear in the main phase, and the crystal magnetic anisotropy of a part of the main phase increases. A plurality of rare-earth elements also diffuse into some of the fluorides and the acid fluorides. These fluorides and acid fluorides contribute to prevention of oxidation of the main phase and increase in coercive force. Further, transitional metal elements are added to the main phase, whereby stabilization of the crystal structure and enhancement of the coercive force can be made compatible. In this case, some of the transitional metal elements diffuses into the fluorides and acid fluorides, or iron and iron-fluorine compounds.

From the above description, the fluorine-containing magnet material which satisfies the following 1) to 6) conditions: (1) the main phase volume accounts for 50% in the volume of magnetic particles; 2) the Curie temperature (Curie point) of the main phase is 200° C. or higher; 3) the saturation magnetic-flux density of the main phase is 1.0 T (tesla) or higher at around 20° C.; 4) the coercive force is 10 kOe or more; 5) the crystal structure of the main phase is stable up to 200° C.; 6) phases other than the main phase are formed on grain boundaries or grain surfaces, and the magnetic properties are stabilized or improved) is

A{Reₗ(Fe_{q}Mᵣ)ₘIₙ}+B{FeₓI_{y}} (1)

as a ferromagnetic material, Re is one or a plurality of rare-earth elements including Y (yttrium), Fe is iron, M is one or more transitional metal elements, I is fluorine alone, fluorine and nitrogen, fluorine and carbon, or fluorine and hydrogen, fluorine and boron, A≧0.5 (50% or more with respect to magnetic particles containing a nonmagnetic phase), A>B>0, l, m, n, q, r, x and y are positive integers, m>n, m>l, x>y, q>r≧0.

Further, at least one of Re, Fe, M and I except for fluorine other than the ferromagnetic phase which can be expressed by the above described expression and is expressed by expression (1) has fluorides or acid fluorides which are contained for diffusion and reaction and grow on the grain boundaries or the grain surfaces, and the fluorine concentration of the aforesaid fluoride or acid fluoride needs to be higher than the fluorine concentration in ferromagnetism. In expression (1), some of fluorine atoms are disposed at an interstitial site of a crystal lattice in both of two ferromagnetic phases, and some of fluorine atoms form a fluorine compound other than that of expression (1), the fluorine compound contains at least one element of Re, Fe and M shown in (1), and a concentration gradient accompanying diffusion of these composing elements is seen in a particle, a film or a sintered body.

There is no problem even if impurities such as oxygen, phosphor, sulfur, copper, nickel, manganese and silicon are unavoidably contained in the ferromagnetic material of the composition expressed by (1) while maintaining the crystal structure. Further, in expression (1), use of a light rare-earth element for Re can realize compatibility of protection of resources and enhancement of magnetic properties more, and can reduce the material cost. In this case, expression (1) becomes

A{LReₗ(Fe_{q}Mᵣ)ₘIₙ}+B{FeₓI_{y}} (2).

LRe is a light rare-earth element containing one or a plurality of yttrium (Y), Fe is iron, M is a transitional metal, I is fluorine alone, or fluorine and nitrogen, or fluorine and carbon, fluorine and hydrogen, or fluorine and boron, A≧0.5 (50% or more with respect to magnetic particles containing a nonmagnetic phase), A>B>0, l, m, n, q, r, x and y are positive integers, m>n, m>l, x>y, and r≧0.

As fluorinating means, means can be adopted such as gas fluorination with use of gas species containing fluorine, a method using diffusion or reaction by using a solution or slurry containing fluorides, a method using plasma, ion implantation, sputtering, and vapor deposition. Since the magnetic properties can be ensured by making the volume fraction of the main phase large, progress of fluorination and oxidation of the inside of the main phase need to be suppressed. The main phase containing at least one rare-earth element including Y has a higher concentration of fluorine disposed at an interstitial site than iron, and n>y is satisfied in expressions (1) and (2). It is conceivable that by including a rare-earth element containing Y, fluorine atoms are easily trapped in a lattice.

In order to dispose fluorine at such an interstitial site, oxygen in the main phase is desirably decreased as much as possible, and forming fluorides on the grain boundaries or the grain surfaces of the main phase and reducing the fluorides are effective as the means of removing oxygen contained in the main phase. That is, in order to progress fluorination while suppressing oxidation of the inside of the main phase, fluorides such as ReF₃ containing oxygen or acid fluorides such as ReOF (Re is a rare-earth element containing Y) are caused to grow on the grain boundaries or the grain surfaces.

Hereinafter, examples will be described. As the materials, Sm—Fe—N—F materials are described in examples 1, 3, 6, 7, 8, 9, 13, 18 and 21, Sm—Fe—F materials are described in examples 2, 20, 23, 29, 30, 31, 32, 33, 34, 36, 37, 39 and 41, an Sm—Fe—Al—F material is described in example 24, Sm—Fe—Ti—F materials are described in examples 25 and 26, an Sm—Fe—Mg—F material is described in example 27, an Sm—Fe—MnF material is described in example 35, an Sm—Pr—Fe—N—F material is described in example 38, Nd—Fe—F materials are described in examples 4 and 40, Nd—Fe—F—N materials are described in examples 5 and 12, Nd—Fe—B—F materials are described in examples 10 and 11, Nd—Fe—Ti—F materials are described in examples 14 and 19, a Y—Fe—Al—F material is described in example 15, a Ce—Fe—C—F material is described in example 16, an La—Fe—N—F material is described in example 17, an La—Fe—Si—Al—F material is described in example 22, and an La—Fe—Mn—F material is described in example 28.

### Example 1

In the present example, a production process of a magnet material and magnetic properties of the produced magnet will be described. Ammonium fluoride particles of 100 g are mixed into Sm₂Fe₁₇N₃ magnetic particles of 100 g, which are less oxidized than Sm₂Fe₁₇, with a particle diameter of 1 to 10 μm. The mixed particles are loaded in a reaction vessel and heated with an external heater. Ammonium fluoride is thermally decomposed by heating, and NH₃ and fluorine-containing gas are generated. Some of N atoms in the magnetic particles start to be replaced with F (fluorine) by the fluorine-containing gas at 200 to 600° C. In the case of a heating temperature of 400° C., some of the N atoms are replaced with F, Sm₂Fe₁₇(N, F)₃ in which fluorine and nitrogen are disposed at interstitial sites grows in a Th₂Zn₁₇ or Th₂Ni₁₇ structure. By setting the cooling speed after heated and held at 1° C./min, some of N and F atoms are regularly arranged. After the reaction ends, the atmosphere is replaced with Ar gas for oxidation prevention. By replacement of F with N, the lattice volume of the compounds locally expands, and the magnetic moment of Fe is increased.

Further, some of N or F atoms are disposed at positions different from the interstitial site before reaction. The magnetic particles containing Sm₂Fe₁₇(N, F)₃ like this contain fluorine of 0.1 at % to 12 at %, and the fluorine concentrations in the main phase in the vicinity of the grain boundaries and the main phase in the grain in the magnetic particles differ from each other by about 0.1 to 5%. Fluorides (SmF₃, FeF₂ and the like) containing oxygen are grown on some of the grain boundaries or the grain boundary triple points.

The basic magnetic properties of the magnetic particles like this are a Curie temperature of 400° C. to 600° C., and a saturation magnetic-flux density of 1.4 to 1.9 T, and a magnet with a residual magnetic-flux density of 1.5 T can be created by molding the magnetic particles. The magnetic particles in which increase of the magnetic moment can be confirmed by introduction of fluorine are ReₗFeₘNₙ (Re is a rare-earth element, l, m, and n are positive integers), ReₗFeₘCₙ (Re is a rare-earth element, l, m and n are positive integers), ReₗFeₘBₙ (Re is a rare-earth element, l, m and n are positive integers), and ReₗFeₘ (Re is a rare-earth element, 1 and m are positive integers) besides Sm₂Fe₁₇N₃. Acid fluorides containing Re grow on the grain boundaries or the particle surfaces of the magnetic particles like this as a result of reduction of the main phase, and the oxygen concentration of the main phase is reduced. Further, even if metal elements such as oxygen, carbon, hydrogen and silicon, sulfur and copper, nickel manganese and cobalt are contained as impurities, the magnetic properties are not changed significantly.

### Example 2

A vapor deposition source is disposed in a vacuum vessel, and Fe is vaporized. The degree of vacuum is 1×10⁻⁴ Torr or less, Fe is vaporized inside the vessel by resistance heating, and particles each with a particle size of 100 nm are produced. The Fe particle surfaces are coated with an alcohol solution containing a composition component of SmF₂₋₃ and are dried at 200° C., and thereby a fluoride film of an average film thickness of 1 to 10 nm is formed on the Fe particle surfaces. The Fe particles coated with the fluoride film is mixed with ammonium fluoride (NH₄F), and are heated by an external heater. A heating temperature is 800° C., and after the mixture is heated and held at 800° C. for one hour or more, the mixture is rapidly cooled to 50° C. or lower at a cooling speed of 100° C./minute at the maximum. A series of process from evaporation of Fe to rapid cooling is performed without opening to atmosphere, whereby particles with an oxygen concentration of 100 to 2000 ppm are obtained.

Some of fluorine atoms are disposed with the atomic sites of Fe moved to sites between tetrahedral lattices or octahedron lattices of unit lattices of Fe. Since ammonium fluorides are used, nitrogen and hydrogen penetrate into the fluoride film other than fluorine. Further, carbon and hydrogen or oxygen atoms in an alcohol solution are also mixed into the Fe particles or the fluoride film. The aforesaid rapidly cooled particles are aged at 200° C. for 10 hours, whereby a compound of Sm₁₋₂Fe₁₄₋₂₀F₂₋₃ of a structure in which Th₂Zn₁₇ structure is expanded by introduction of fluorine or a CaCu₅ structure grows. The concentration distribution of fluorine atoms is seen in a center direction from the surface of the rapidly cooled particles, the fluorine concentration shows tendency to be higher at the outer peripheral side of the rapidly cooled particles than in the center, and compounds such as SmF₃ or SmOF grow on some of the grain boundaries or the grain surfaces. Growth of acid fluorides shows a result that oxygen in the magnetic particles diffuses in the magnetic particles before fluorinating treatment, and can reduce the oxygen concentration inside the magnetic particles. The magnetic properties of the magnet which is obtained by compression molding or sintering the particles are a residual magnetic-flux density of 1.3 to 1.5 T, a coercive force of 20 to 30 kOe, a Curie temperature becomes 480° C., and the magnet can be applied to various magnetic circuits such as a motor and medical equipment.

### Example 3

Ammonium fluoride particles of 100 g with an average particle size of 0.1 μm are mixed into Sm₂Fe₁₇N₃ magnetic particles of 100 g with an average particle size of 1 to 10 μm coated with 0.5 wt % of an alcohol solution with SmF fluorides swelled. The mixed particles are loaded in a reaction vessel and heated with an external heater. Ammonium fluoride is thermally decomposed by heating, and NH₃ and fluorine-containing gas are generated. Some of N atoms in the magnetic particles start to be replaced with F (fluorine) at 200 to 600° C. by the fluorine-containing gas. In the case of a heating temperature of 300° C., some of the N atoms are replaced with F, Sm₂Fe₁₇(N, F)₃ or Sm₂Fe₁₇(N, F)₂ grows with SmOF formation on the particle surfaces. By setting the cooling speed after heated and held at PC/min, some of N and F atoms are regularly arranged. After the reaction ends, the atmosphere is replaced with Ar gas for oxidation prevention. By replacement of F with N, the lattice volume of the compounds expands, and the magnetic moment of Fe is increased. Further, some of N or F atoms are disposed at positions different from the interstitial site before the reaction.

The magnetic particles containing Sm₂Fe₁₇(N, F)₃ like this contain fluorine of 0.5 at % to 12 at %, and show the magnetic properties of a Curie temperature of 400° C. to 600° C., and a saturation magnetic-flux density of 1.4 to 1.9 T, and a magnet with a residual magnetic-flux density of 1.5 T can be created by molding the magnetic particles in an ammonium fluoride atmosphere at 400° C.

A result of measuring fluorine and nitrogen by a mass spectrometer from the surfaces of the magnetic particles is shown in FIG. 1. Black dots correspond to fluorine concentrations, and white dots correspond to nitrogen concentrations. The fluorine concentration becomes the maximum at the depth of about 1.25 μm from the magnetic particle surfaces, the nitrogen concentration shows tendency of being lower in the surface, and it is found out the concentration distributions of fluorine and nitrogen differ with respect to the depth direction. Nitrogen atoms diffuse inside with fluorine introduction by heating at 300° C., and nitrogen is estimated to diffuse to the center portion of the particles more than fluorine. By formation of the phase with the fluorine concentration higher than nitrogen concentration on the surfaces, the compounds in which more fluorine atoms than nitrogen atoms are interstitially disposed can be formed, and the residual magnetic-flux density can be increased.

The magnetic particles in which increase of the magnetic moment can be confirmed by introduction of fluorine are ReₗFeₘNₙ (Re is a rare-earth element, and l, m and n are positive integers) or ReₗCOₘNₙ (Re is a rare-earth element, and l, m and n are positive integers) of a CaCu₅ structure and a tetragonal structure, ReₗMnₘNₙ, (Re is a rare-earth element, and l, m and n are positive integers), ReₗCrₘNₙ (Re is a rare-earth element, and l, m and n are positive integers), and ReₗMnₘOₙ (Re is a rare-earth element, and l, m and n are positive integers) besides Sm₂Fe₁₇N₃. Compounds in which some of fluorine atoms like this are disposed at the interstitial sites of the lattices can be produced with a thin film, a thick film, a sintered body, and a foil body besides the magnetic particles, and even if acid fluorides containing Re grow on the grain boundaries and the magnetic particle surfaces of the inside of the fluorine-containing ferromagnetic material, and oxygen, carbon and metal elements as impurities are contained, the magnetic properties does not change significantly.

### Example 4

After Fe particles in an indefinite shape with an average particle size of 1 μm is reduced by hydrogen, and oxygen is removed from the surfaces, the Fe particles are mixed with an NdF alcohol solution in which fluorides of the composition close to that of NdF_{3.1-3.5} are swelled, and an amorphous NdF film is formed on the surfaces. The average film thickness after coating and drying is 10 nm. After the Fe particles coated with the amorphous fluorides are mixed with ammonium fluoride particles and heated at 600° C. for 10 hours, the mixture is aged at 200° C., whereby fluorine atoms and nitrogen atoms diffuse from the Fe particle surfaces, and atomic arrangements of fluorine and nitrogen are unit lattices and lattices with anisotropy can be confirmed. Some of the fluorine atoms and nitrogen atoms are regularly arranged and increase the magnetic moment of Fe. Further, some of Nd atoms also diffuse into the Fe particles.

A magnetic field is applied to particles like this at 100° C. or lower, a load of 1 t/cm² is applied, and a preform is produced. The preform is heated and molded in an ammonium fluoride gas, whereby particles of a Th₂Zn₁₇ structure can be sintered. Magnetic particles are oriented by a magnetic field before sintering, an anisotropic magnet can be produced, and the magnetic properties at 20° C. show a residual magnetic-flux density of 1.5 T, and a coercive force of 25 kOe. Nd₂Fe₁₇F₂ is partially in contact with acid fluorides on the grain boundaries or the grain surfaces by sintering, NdOF of a cubic crystal or a rhombohedral crystal can be confirmed in the acid fluorides, and some of the acid fluoride compounds have a regular phase. Further, in the ratio of fluorine and nitrogen of substantially 1:1, the Curie temperature is 490° C.

### Example 5

After Fe particles in an indefinite shape with an average particle size of 1 μm is reduced by hydrogen, and oxygen is removed from the surfaces, the Fe particles are mixed with an NdF alcohol solution, and an amorphous NdF film is formed on the surfaces. The average film thickness is 1 to 10 nm. After the Fe particles coated with the amorphous fluorides are mixed with ammonium fluoride particles and heated at 400° C. for 100 hours, the mixture is held at 200° C. for 10 hours and aged, whereby fluorine atoms and nitrogen atoms diffuse from the Fe particle surfaces, atomic arrangements of fluorine and nitrogen are unit lattices and lattices with anisotropy can be confirmed. Some of the fluorine atoms and nitrogen atoms are regularly arranged and the distances between Fe atoms are increased, whereby the magnetic moment of Fe is increased. Some of Fe atoms form an Fe₁₆F₂ phase which is a regular phase with fluorine. Further, some of Nd atoms also diffuse into the Fe particles, and Nd₂Fe₁₇(N, F)₃ grows.

A magnetic field is applied to the particles like this at 100° C. or lower, a load of 1 t/cm² is applied, and a preform is produced. Heating molding with the preform being irradiated with a magnetic wave in an ammonium fluoride gas is carried out, whereby particles containing ferromagnetic phases of a Th₂Zn₁₇ structure and a tetragonal structure can be sintered. Magnetic particles are oriented by a magnetic field before sintering, an anisotropic magnet can be produced, and the magnetic properties at 20° C. show a residual magnetic-flux density of 1.5 T, and a coercive force of 25 kOe. NdOF partially grows in triple points of the grain boundaries after sintering, and the oxygen concentration of the main phase is reduced. Further, in the ratio of fluorine and nitrogen of substantially 1:1, the Curie temperature is 490° C.

### Example 6

After Fe particles in an indefinite shape with an average particle size of 1 μm is reduced by hydrogen, and oxygen is removed from the surfaces, the Fe particles are mixed with an SmF alcohol solution, and an amorphous SmF film is formed on the surfaces. The average film thickness is 20 nm. After the Fe particles coated with the amorphous fluorides are mixed with ammonium fluoride particles and heated at 400° C. for 100 hours, the mixture is held at 200° C. for 10 hours and aged, whereby fluorine atoms and nitrogen atoms diffuse from the Fe particle surfaces, atomic arrangements of fluorine and nitrogen are unit lattices and lattices with anisotropy can be confirmed. Some of the fluorine atoms and nitrogen atoms are regularly arranged and the distances between Fe atoms are increased, whereby the magnetic moment of Fe is increased. Some of Sm atoms also diffuse into the Fe particles, and Sm₂Fe₁₇(N, F)₃ grows with acid fluorides on the grain boundaries or the grain surfaces.

A magnetic field is applied to the particles like this at 100° C. or lower, a load of 1 t/cm² is applied, and a preform is produced. After the preform is impregnated with an SmF alcohol solution, and an alcohol content is dried and removed, heating molding with the preform being irradiated with a magnetic wave in an ammonium fluoride gas is carried out, whereby particles containing ferromagnetic phases of a Th₂Zn₁₇ structure and a tetragonal structure can be sintered. Magnetic particles are oriented by a magnetic field before sintering, an anisotropic magnet can be produced, and the magnetic properties at 20° C. show a residual magnetic-flux density of 1.5 T, and a coercive force of 30 kOe. A fluorine rich phase is formed in the grain boundaries, and a matrix phase contains fluorine and nitrogen. The fluorine concentration in the vicinity of the grain boundaries and the grain surfaces is higher than the fluorine concentration of the grain center, and the lattice constant also tends to be larger. This shows that the Curie temperature and the crystal magnetic anisotropy energy in the grain boundaries or the grain surfaces are higher at the outer peripheral side or surfaces than the grain center. Further, some of fluorine atoms are bound with oxygen and forms acid fluorides, whereby the oxygen concentration of the inside of Fe particles is reduced. In the ratio of fluorine and nitrogen of substantially 1:1, the Curie temperature is 490° C., and as the fluorine concentration of the matrix phase becomes higher, the Curie temperature shows the tendency to be higher.

### Example 7

After Sm₂Fe₁₈ particles in an indefinite shape with an average particle size of 0.1 μm is reduced by hydrogen, and oxygen is removed from the surfaces, the Sm₂Fe₁₈ particles are mixed with a transparent SmF alcohol solution close to an SmF₃ composition, and an amorphous SmF film (Sm:F=1:3) is formed on the surfaces. The average coating film thickness is 20 nm. After the Fe particles coated with the amorphous Sm fluorides are mixed with ammonium fluoride particles and heated at 400° C. for 100 hours, the mixture is held at 200° C. for 10 hours and aged, whereby fluorine atoms and nitrogen atoms diffuse from the Fe particle surfaces, atomic arrangements of fluorine and nitrogen are unit lattices and lattices with anisotropy can be confirmed. Some of the fluorine atoms and nitrogen atoms or carbon atoms are regularly arranged and the distances between Fe atoms are increased, whereby the magnetic moment of Fe is increased. Further, some of Sm atoms in fluorides also diffuse into the Fe particles, and Sm₂Fe₁₇(N, F)₃ mainly of a Th₂Zn₁₇ structure of the main phase, and an Fe—F binary alloy phase mainly of a tetragon or a cubic crystal structure grows.

A magnetic field is applied to the particles like this at a temperature of 100° C. or lower, a load of 1 t/cm² is applied, and a preform is produced. After the preform is impregnated with an SmF alcohol solution, and an alcohol content is dried and removed, heating molding with the preform being irradiated with a magnetic wave in an ammonium fluoride gas is carried out, whereby particles containing ferromagnetic phases of a Th₂Zn₁₇ structure and a tetragonal structure can be sintered. Magnetic particles are oriented by a magnetic field before sintering, and sintered, whereby an anisotropic magnet can be produced, and the magnetic properties at 20° C. show a residual magnetic-flux density of 1.6 T, and a coercive force of 30 kOe. A fluorine rich phase and an Fe rich phase are formed in the grain boundaries, and a matrix phase contains fluorine and nitrogen. In the vicinity of the grain boundaries, an Fe₁₆F₂ or Fe₁₆(F, N)₂ phase, which is a regular phase of a tetragonal structure, or an Fe₁₆(F, N, C)₂ phase with a crystal grain smaller than the main phase crystal grain grows, and acid fluorides (SmOF) with a high fluorine concentration grows in the grain boundaries. Further, some of fluorine atoms are bound with oxygen, carbon, or nitrogen to form acid fluorides containing carbon or nitrogen. In the ratio of fluorine and nitrogen of the main phase of substantially 10:1, the Curie temperature is 510° C., and as the fluorine concentration of the matrix phase becomes higher, the Curie temperature shows the tendency to be higher. The volume fraction of the main phase with respect to an entire bulk is set as A, and a phase mainly of Fe—F which is ferromagnetic iron is set as B. The Fe—F phase includes a bcc structure and a bct structure. A and B are obtained by analysis of mapping of SEM-EDX (energy diffusion type X-ray spectral) and TEM-EDX or analysis of mapping of EBSP (electron backscattering pattern) and X-ray diffraction.

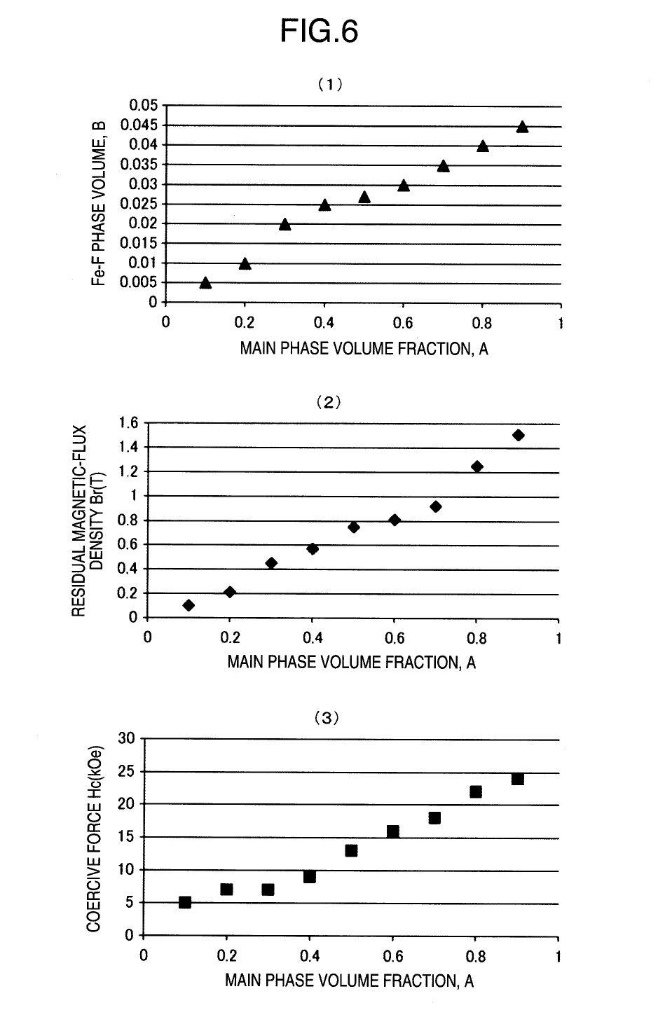

A and B can be controlled by changing parameters of sinter conditions, fluorinating conditions, preform conditions and the like, and one example thereof is shown in FIG. 6(1). As the main phase volume fraction A increases, the Fe—F phase volume fraction B tends to increase, but the Fe—F phase volume fraction B is about 5% of the main phase volume fraction A. When the Fe—F phase volume fraction B is less than 20%, growth of the Fe—F phase contributes to increase of a residual magnetic-flux density Br, but when the Fe—F phase volume fraction B exceeds 50%, reduction of the coercive force becomes remarkable, and the particles hardly becomes a magnet material. This shows that due to growth of the Fe—F phase with ferromagnetic binding with the main phase being weak because the Fe—F phase volume fraction increases, the Fe—F phase becomes a softly magnetic, and the coercive force reduces.

As shown in FIG. 6(2), when the main phase volume fraction A increases, the residual magnetic-flux density Br tends to increase. Considering application of the present magnet to the magnetic circuit of a motor or the like, a necessary residual magnetic-flux density Br is 0.7 T. NdFeB and SmFeN magnets having a residual magnetic-flux density of 0.7 T are already produced in volume, but with the main phase volume rate of 50%, the aforesaid mass-production magnets do not achieve 0.7 T. When the Th₂Zn₁₇ structure and the analogous structure in which the main phase contains fluorine as the present example are mainly present, due to increase of the residual magnetic-flux density by the magnetic moment increase effect, the residual magnetic-flux density of 0.75 T is obtained in the main phase volume fraction of 0.5 as shown in FIG. 6(2), and contribution can be made to reduction in size and weight of various components and products through reduction in weight and size of the magnet.

Further, the coercive force shows a low value when the main phase volume factor is small, magnetic particles separate in the forming body, magnetic particles magnetically isolated or magnetic particles with the surface oxidized are present, and therefore, the coercive force is considered to be small. In the magnetic circuit of a motor or the like, the magnetic field in the direction opposite from the magnetizing direction of the magnet is added, and therefore, a coercive force of 10 kOe is needed. In order to ensure the coercive force of 10 kOe, the main phase volume fraction A needs to be 0.5 or higher as shown in FIG. 6(3). The coercive force of 10 kOe and the residual magnetic-flux density of 0.7 T or higher are one of indexes for commercialization, and in order to satisfy the index, making the main phase volume fraction A 0.5 or higher is necessary. The characteristics of the coercive force of 10 kOe and the residual magnetic-flux density of 0.7 T or higher are also the values necessary for application to a magnetic circuit in a bulk sintered magnet and a tin film magnet. In order to satisfy the aforesaid values, the volume fraction of the ferromagnetic phase containing a rare-earth element and iron and fluorine which is a main phase needs to be made 0.5 or more, in not only a sintered magnet, but also a thin film magnet, a bond magnet, a pressure-molded magnet and a magnet produced by an electrochemical method from a solution.

As the phases other than the main phase, the aforesaid Fe—F phase, fluorides and acid fluorides are cited. Of the above, the Fe—F phase is a ferromagnetic phase and therefore, significantly influences the magnetic properties of the main phase, and the magnetic properties of the magnet are improved since replacement binding acts between the main phase and the Fe—F phase, but if the Fe—F phase increases, when the magnetic field opposite from the magnetization direction is applied to the magnet, magnetization of the main phase is easily inversed. Therefore, it is desirable to make the Fe—F volume fraction less than 0.5 (50%). Further, fluorides, acid fluorides or rare-earth oxides, iron oxides, and iron fluorides grow in the grain boundaries or the particle surfaces, and the fluorine concentration becomes higher in the grain boundaries or the grain surfaces in which fluorine-containing compounds grow more than the grain center portions. The fluorine-containing compounds like this have the function of reducing the oxygen concentration of the ferromagnetic phase, enhance structure stability of the fluorine-containing ferromagnetic phase, and the coercive force is increased.

Further, the characteristics of the present magnet are shown as follows: 1) a high Curie temperature can be achieved without use of a heavy rare-earth element; 2) a fluorine rich phase is formed on the grain boundaries and can be sintered; 3) a bond magnet with the magnetic particles fixed in a resin can be produced; 4) nitrogen or fluorine atoms are partially arranged in the main phase or an iron rich phase regularly; 5) acid fluorides grow in the vicinity of the grain boundaries and suppresses oxidation of the main phase; 6) the magnitude and direction of the magnetic anisotropy, the Curie temperature, and magnetic moment can be controlled in accordance with the ratio of atoms to an interstitial site, and the anisotropy magnetic field reaches 25 MA/m; 7) regularity of the matrix phase or the Fe rich phase changes and the magnetic properties change, in accordance with the ratio of the penetrating atoms; and 8) in order to stabilize the structure of the main phase in which fluorine is arranged at the interstitial site, various transitional metals and rare-earth elements can be added as the third elements.

The magnet like this can be produced with respect to not only the material containing Sm, Fe and F but also all the other rare-earth elements including yttrium, and at least two kinds of phases grow as ferromagnetic phases. The two kinds of ferromagnetic phases are of ferromagnetic iron having a large quantity of a phase having high magneto crystalline anisotropy and containing a rare-earth element including Y and iron. Besides the two kinds of ferromagnetic phases, oxides containing iron and a rare-earth element, fluorides or acid fluorides grow, but these substances have magnetization smaller than magnetization of the aforesaid two kinds of ferromagnetic phases, and the volume thereof is smaller than that of the aforesaid two phases. Summarizing the example with these examples included, the summary can be expressed as follows. That is, the above described ferromagnetic material contains fluorine and iron, and in the magnetic material containing some of fluorine atoms, the ferromagnetic material is constituted of phases having at least two kinds of compositions, as for the main composition of the ferromagnetic material, and by being brought into correspondence with the aforesaid two kinds of phases shown by the following expression, the ferromagnetic phase is composed by the expression

A{Reₗ(Fe_{q}Mᵣ)ₘIₙ}+B{FeₓI_{y}}.

Here, A and B represent respective volume fractions of the phase constituted of Re, Fe and I, and the phase constituted of Fe and I, with respect to particles, a bulk sintered body or an entire thin film, Re represents one or a plurality of rare-earth elements including Y, Fe represents iron, M represents a transitional metal element, I represents fluorine alone, fluorine and nitrogen, or fluorine and carbon, or fluorine and hydrogen, or fluorine and boron, A≧0.5 (50% or more of the magnet material), A>B>0, l, m, n, q, r, x and y are positive integers, and can be described as m>n, m>l, x>y, q>r≧0, fluorides and acid fluorides are formed in some of the grain boundaries or the grain surfaces, the fluorine concentration of the aforesaid fluorides or acid fluorides is higher than the fluorine concentration in ferromagnetism.

In the ferromagnetic body like this, at least part of ferromagnetic iron is ferromagnetically bound with the main phase, and increases the residual magnetic-flux density. Further, part of fluorine diffuses to the main phase from the fluorides formed in the grain boundaries or the grain surfaces, whereby the concentration gradient of fluorine is formed from the grain surfaces or grain boundaries to the grain center portions, and the lattice constant and the lattice volume are also changed. Here, the lattice volume of the main phase is larger than the lattice volume of the body-centered cubic crystal or the body-centered tetragonal crystal of fluorine-containing ferromagnetic iron because the lattice volume of the main phase is the lattice containing a rare-earth element, iron and fluorine.

Further, the portions containing high fluorine concentrations of the grain surfaces or the grain boundaries have large magneto crystalline anisotropy, and in the high-fluorine concentration portions and the low-fluorine concentration portions of the grain center portions, part of the crystal lattices is continuous and lattice conformity is confirmed. This shows that the lattice volume or the lattice strain changes in the similar crystal structure in one crystal grain or magnetic particles, and high magneto crystalline anisotropy of the phase with a large lattice volume by fluorine introduction leads to increase in the coercive force, increase in the residual magnetic-flux density, and rise of the Curie temperature. Further, some of the fluorine atoms disposed at the interstitial sites have regularly arranged long-period structures, and thereby stabilize the crystal structures more and are hardly decomposed thermally, and stability of the crystal structure is confirmed up to 800° C. which is higher than a Curie temperature by adding transitional metal elements to the main phase.

### Example 8

Ammonium hydrogen fluoride particles of 10 g with a particle size of 0.01 μm are mixed into Sm₂Fe₁₇N₃ magnetic particles of 100 g with a particle size of 1 μm. The mixed particles are loaded in a reaction vessel and heated with an external heater. The ammonium hydrogen fluoride is thermally decomposed by heating, and NH₃ and fluorine-containing gas are generated. The oxide phase on the aforesaid magnetic particle surfaces is removed by the gas generation, and the oxygen concentration becomes 100 ppm or lower. At 200° C., some of the N atoms in the magnetic particles start to be replaced with F (fluorine) by a fluorine-containing gas. In the case of a heating temperature of 200° C., part of N is replaced with F, and Sm₂Fe₁₇(N, F)₃ grows with SmF₃ and SmOF. At the same time, a regular phase such as Fe₁₆F₂ grows on the Fe-rich phase. The cooling speed after heating and holding is set at 1° C./min, whereby some of N atoms and F atoms are regularly arranged, and Fe₁₆(F, N)₂ and the like grow. After the reaction ends, the atmosphere is replaced with an Ar gas for oxidation prevention. In order to enhance anisotropy during the reaction, a magnetic field of 1 T or higher may be applied. F is replaced with N, the lattice volumes of the main phase and the Fe rich phase expand, and the magnetic moment of Fe increases by about 10%.

Further, some of N atoms or F atoms are disposed at the positions different from the interstitial sites before the reaction. The magnetic particles containing Sm₂Fe₁₇(N, F)₃ like this contain 0.5 at % to 5 at % of fluorine, and show the magnetic properties of a Curie temperature of 400° C. (0.5% of fluorine) to 600° C. (5% of fluorine), and a saturation magnetic-flux density of 1.4 (0.5% of fluorine) to 1.7 T (5% of fluorine), and the magnetic particles are molded in an ammonium hydrogen fluoride atmosphere, whereby a magnet with a residual magnetic-flux density of 1.6 T can be produced. The magnetic particles in which increase of the magnetic moment can be confirmed by introduction of fluorine are Reₗ(Fe, Co)ₘNₙ (Re is a rare-earth element, and l, m and n are positive integers), Reₗ(Fe, Co)ₘNₙ (Re is a rare-earth element, and l, m and n are positive integers), Reₗ(Mn, Cr)ₘNₙ (Re is a rare-earth element, and l, m, and n are positive integers), Reₗ(CrNi)ₘNₙ (Re is a rare-earth element, and l, m, n are positive integers), and Reₗ(Mn, Cr)ₘOₙ (Re is a rare-earth element, and l, m and n are positive integers), and these fluorine-containing compounds are formed with fluorides and acid fluorides which are substantially nonmagnetic besides Sm₂Fe₁₇N₃.

Even if in the magnetic particles like this, growth of acid fluorides and oxygen, carbon and metal elements as impurities are contained in the grain boundaries inside the particles and the magnetic particle surfaces, the magnetic properties do not change significantly, and with increase in the magnetic moment, the following effect can be confirmed: 1) increase in the internal magnetic field; 2) increase in magneto crystalline anisotropy; 3) change of the direction of magnetic anisotropy; 4) increase in electric resistance; 5) change of the temperature coefficient of the saturation magnetic-flux density; 6) change of the magnetic resistance, 7) change of the heat quantity accompanying phase transition; and 8) phase transition related to movement of an atomic site of fluorine when heating the magnetic particles to a Curie temperature or higher, and the like.

### Example 9

Ammonium hydrogen fluoride particles of 10 g are mixed into particles of 200 g in which Sm₂Fe₁₇N₃ with a particle size of 5 μm as a main phase and 1 volume % of iron mixes in the same particles and grows. The mixed particles are loaded in a reaction vessel and heated with an external heater. The ammonium hydrogen fluoride is thermally decomposed by heating, and NH₃ and fluorine-containing gas are generated. The oxide phase on the aforesaid magnetic particle surfaces is removed by the gas generation, and the oxygen concentration becomes 70 ppm. At 200° C., some of the N atoms in the magnetic particles start to be replaced with F (fluorine) by a fluorine-containing gas. In the case of a heating temperature of 300° C., part of N is replaced with F, and Sm₂Fe₁₇(N, F)₃ grows. At the same time, a regular phase such as Fe₁₆F₂ grows on the Fe-rich phase having a bcc structure or a bct structure. The cooling speed after heating and holding is set at 1° C./min, whereby some of N atoms and F atoms are regularly arranged, and Fe₁₆(F, N)₂ and the like grow. After the reaction ends, the magnetic particle surfaces are irradiated with fluorine ions, the fluorine concentration at the interstitial site is further made high, and the magnetic moment is increase by about 5%. An irradiation amount is 5×10¹⁶/cm². During irradiation, the site of the magnetic particles is changed, and the magnetic particle surfaces are irradiated by 50% or more. Irradiation may be performed a plurality of times by changing the irradiation amount and the irradiation energy. The fluorine concentration after irradiation becomes the maximum at the depth of 0.1 to 3 μm in the magnetic particle center direction from the magnetic particle surfaces rather than on the magnetic particle outermost surfaces. In order to enhance anisotropy during the irradiation, a magnetic field of 1 T may be applied. F is replaced with N, and thereby, the C-axes of the main phase and the Fe-rich phase extend, whereby the lattice volumes of the tetragonal crystal expand, and the magnetic moment of Fe increases by about 10%. Further, some of N atoms or F atoms are disposed at the sites different from the interstitial sites before the reaction.

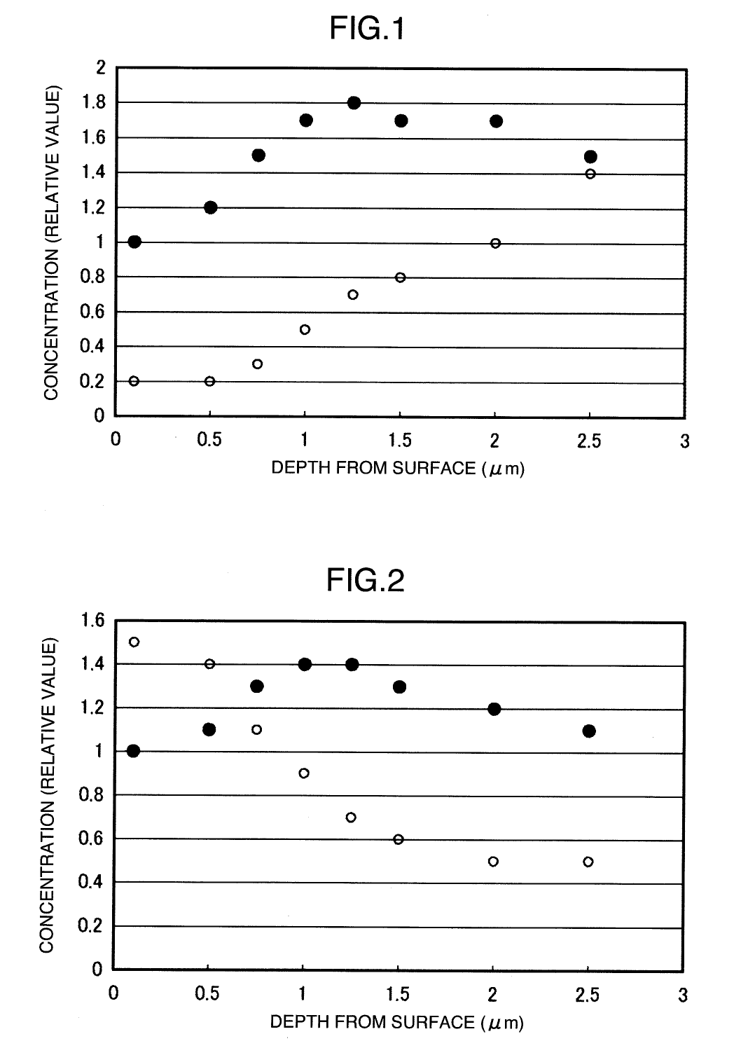

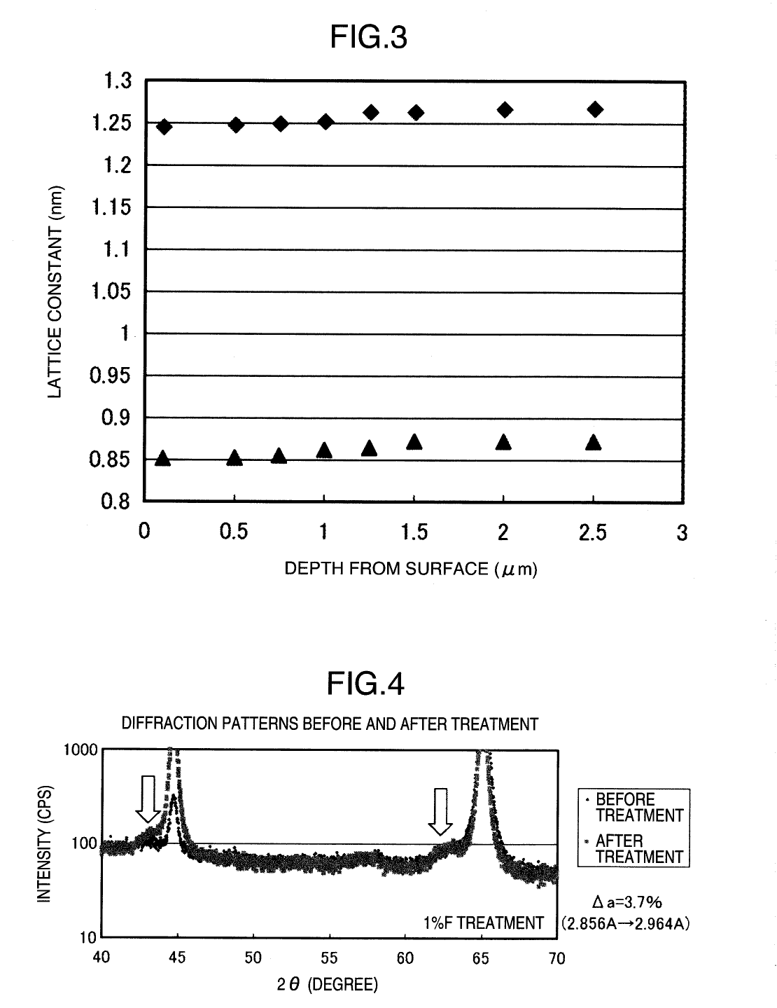

An analysis example of fluorine and nitrogen concentrations is shown in FIG. 2. The black dots correspond to fluorine concentrations, and white dots correspond to the nitrogen concentrations. The maximum value of the fluorine concentration is at the depth of 1 to 1.3 μm from the surface, and the nitrogen concentration is higher as it is in the surface layer. The magnetic particles containing Sm₂Fe₁₇(N, F)₃ like this contain 4 at % to 9 at % of fluorine, and the distribution in the depth direction of the lattice constant is as shown in FIG. 3. The lattice constant is large at the depth exceeding 1 μm from the surface layer with a high fluorine concentration, and the unit cell volume is also large. The magnetic particles show the magnetic properties of a Curie temperature of 420° C. (4% of fluorine) to 650° C. (9% of fluorine), and a saturation magnetic-flux density of 1.5 (4% of fluorine) to 1.8 T (9% of fluorine), and the magnetic particles are molded in an ammonium hydrogen fluoride atmosphere at 400° C., whereby a magnet with a residual magnetic-flux density of 1.7 T can be produced.

Further, when the iron particles at a degree of purity of 99% are treated under the same conditions as the present example, diffraction peaks are seen at diffraction angles shown by the arrows in an XRD pattern before and after the treatment as shown in FIG. 4. It is found out that at the sites with small diffraction angles, peaks each with a large half value width and small strength are observed, and spacing of lattice planes of iron increases. More specifically, it is obvious that the lattice constant of iron extends by the treatment, and the change is an extension by about 3.7%. Increase of the lattice constant like this shows that fluorine atoms are disposed at the interstitial sites of tetrahedral sites or octahedral sites, and contributes to increase of a magnetic moment of iron atoms. The magnetic particles in which increase of the magnetic moment can be confirmed by introduction of a gas including fluorine atoms or implantation of fluorine ions are ReₗCOₘNₙ (Re is a rare-earth element, and l, m and n are positive integers), ReₗMnₘNₙ (Re is a rare-earth element, and l, m and n are positive integers), ReₗCrₘNₙ (Re is a rare-earth element, and l, m, and n are positive integers), and ReₗMnₘOₙ (Re is a rare-earth element, and l, m and n are positive integers) besides Sm₂Fe₁₇N₃.

Even if in the magnetic particles like this, growth of acid fluorides, oxygen, carbon, boron and metal elements as impurities are contained in the grain boundaries inside the particles and the magnetic particle surfaces, the magnetic properties do not change significantly, and with increase in the magnetic moment, the following effects can be confirmed: 1) increase in the internal magnetic field; 2) increase in magneto crystalline anisotropy; 3) change of the direction of magnetic anisotropy; 4) increase in electric resistance; 5) change of the temperature coefficient of the saturation magnetic-flux density; 6) change of the magnetic resistance, 7) change of the heat quantity accompanying phase transition; and 8) phase transition related to movement of an atomic site of fluorine when heating the magnetic particles to a Curie temperature or higher, and the like. The crystal structure of a magnetic substance in which some of fluorine atoms disposed in interstitial sites as described above is of a metastable phase, and therefore, phase transition to a stable phase occurs by heating. A plurality of phase transitions occur, and at least one phase transition progresses at 300° C. to 400° C. In order to set the phase transition temperature to a high temperature side, it is effective to form an ordered main phase with the elements disposed in the other interstitial sites, add a plurality of rare-earth elements, and form fluorides or acid fluorides conforming to a regular phase in the grain boundaries, and by these methods, the phase transition temperature and the Curie temperature can be made substantially the same.

### Example 10

Ammonium hydrogen fluoride particles of 10 g are mixed into particles of 200 g containing Nd₂Fe₁₄B with a particle size of 5 μm as a main phase. The mixed particles are loaded in a vessel which does not directly react with magnetic particles and heated with an external heater. The ammonium hydrogen fluoride is thermally decomposed by heating, and NH₃ and fluorine-containing gas are generated. The oxide phase on the aforesaid magnetic particle surfaces is removed by the gas generation, and the oxygen concentration becomes 120 ppm. At 400° C., some of the B atoms in the magnetic particles start to be replaced with F (fluorine) by a fluorine-containing gas. In the case of a heating temperature of 400° C., part of B is replaced with F, and Nd₂Fe₁₄(B, F) grows. At the same time, a regular phase of Fe₁₆F₂ having a lattice constant about twice as large as that of iron of a bcc structure and a lattice volume larger than iron by about 5 to 15% grows on the Fe-rich phase having a bcc structure or a bct structure, and part of the Nd-rich phase of an fcc structure becomes acid fluorides of the fcc structure. The cooling speed after heating and holding is set at 1° C./min, whereby some of B atoms and F atoms are regularly arranged, and Fe₁₆(F, B)₂ and the like grow.

After the reaction ends, the magnetic particle surfaces are irradiated with fluorine ions, the fluorine concentration at the interstitial site is further made high, and the magnetic moment is increased by about 3%. The irradiation amount is 1×10¹⁶/cm². During irradiation, the site of the magnetic particles is changed, and the magnetic particle surfaces are irradiated by 50% or more. Irradiation may be performed a plurality of times by changing the irradiation amount and the irradiation energy. The fluorine concentration after irradiation becomes the maximum at the depth of 0.1 to 3 μm in the magnetic particle center direction from the magnetic particle surfaces rather than on the magnetic particle outermost surfaces. In order to enhance anisotropy during the irradiation, a magnetic field of 1 T may be applied. F is replaced with N, and thereby, the c-axes of the main phase and the Fe-rich phase extend, whereby the lattice volumes of the tetragonal crystal expand, and the magnetic moment of Fe increases by about 5%.

Further, some of N atoms or F atoms are disposed at the sites different from the interstitial sites before the reaction. The magnetic particles containing Nd₂Fe₁₄(B, F) like this contain 1 at % to 5 at % of fluorine, and show the magnetic properties of a Curie temperature of 320° C. (1% of fluorine) to 380° C. (5% of fluorine), and a saturation magnetic-flux density of 1.61 (1% of fluorine) to 1.72 T (5% of fluorine), and the magnetic particles are molded in an ammonium hydrogen fluoride atmosphere at 400° C., whereby a magnet with a residual magnetic-flux density of 1.7 T can be produced.

As described above, the magnetic particles in which increase of the magnetic moment can be confirmed by introduction of a gas including fluorine atoms or implantation of fluorine ions are ReₗCOₘBₙ (Re is a rare-earth element, and l, m and n are positive integers), ReₗMnₘBₙ (Re is a rare-earth element, and l, m and n are positive integers), ReₗCrₘBₙ (Re is a rare-earth element, and l, m, and n are positive integers), and Reₗ(Mn, Al)ₘBₙ (Re is a rare-earth element, and l, m and n are positive integers), besides Nd₂Fe₁₄(B, F). Even if in the magnetic particles like this, growth of acid fluorides, oxygen, carbon, boron and metal elements as impurities are contained in the grain boundaries inside the particles and the magnetic particle surfaces, the magnetic properties do not change significantly, and with increase in the magnetic moment of some of the Fe atoms, the following effects can be confirmed: 1) increase in the internal magnetic field; 2) increase in magneto crystalline anisotropy; 3) change of the direction of magnetic anisotropy; 4) increase in electric resistance; 5) change of the temperature coefficient of the saturation magnetic-flux density; 6) change of the magnetostriction, 7) change of the heat quantity accompanying phase transition; and 8) phase transition related to movement of an atomic site of fluorine when heating the magnetic particles to a Curie temperature or higher, and the like. When the magnet in which ferromagnetic iron with the Nd₂Fe₁₄(B, F) structure produced as described above as a main phase and having a bcc or bct structure containing fluorine grows is bonded to a layer-built electromagnetic steel plate, layer-built amorphous or green compact iron to produce a rotator, the magnet is disposed in a site for insertion in advance.

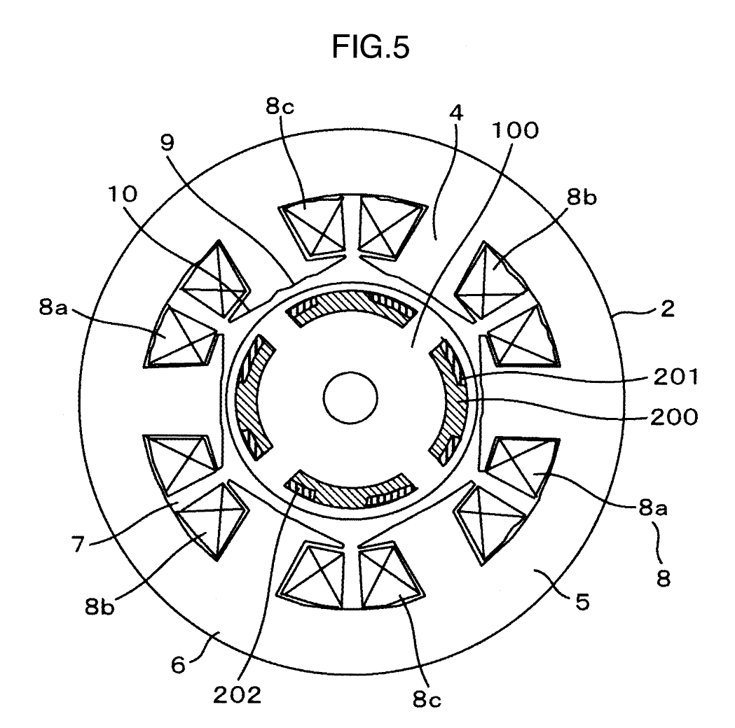

FIG. 5 shows a schematic view of a section perpendicular to an axial direction of a motor. The motor is constituted of a rotator 100 and a stator 2, the stator is constituted of a core back 5 and teeth 4, and in coil insertion positions 7 between teeth 4, a coil group of a coils 8a, 8b and 8c (a U-phase winding 8a, a V-phase winding 8b and a W-phase winding 8c) is inserted. A rotor insertion 10 which the rotor enters is ensured in the shaft center from a tip end portion 9 of the teeth 4, and the rotor 100 is inserted in the position. A fluorine-containing magnet with surface treatment such as plating applied is inserted in the outer peripheral side of the rotor 100, and the fluorine-containing magnet is constituted of a portion with less iron fluorides (average fluorine atom concentration in iron of less than 5%) 200, fluorinated portions with many iron fluorides (average fluorine concentration in iron of 5% to 10%) 201 and 202. The areas of the portions 201 and 202 with the fluorine concentrations of 5 to 10 at % differ from each other in the iron phase constituting the magnet, the portion having larger magnetic field strength with an inverse magnetic field being applied by the magnetic field design is subjected to fluoride treatment in a wide area and the coercive force and the residual magnetic-flux density are enhanced. By increasing the iron fluorides in the outer peripheral side of the sintered magnet, the use amount of rare-earth elements can be decreased. The above described fluorine treatment also can be applied to a soft magnetic portion of a magnetic circuit, the saturation magnetic-flux density can be enhanced to 2.4 to 2.6 T, and can be applied to various motors, hard disk magnetic heads, and measurement devices such as MRI, an electron microscope, and superconductor equipment.

### Example 11

Ammonium hydrogen fluoride particles of 10 g are mixed into particles of 200 g containing Nd₂Fe₁₄B with a particle size of 1 μm as a main phase. The mixed particles are loaded in a vessel which does not directly react with magnetic particles and heated with an external heater. The ammonium hydrogen fluoride is thermally decomposed by heating, and NH₃ and fluorine-containing gas are generated. The oxide phase on the aforesaid magnetic particle surfaces is removed by the gas generation, and the oxygen concentration becomes 120 ppm. At 400° C., some of the B atoms in the magnetic particles start to be replaced with F (fluorine) by a fluorine-containing gas. In the case of a heating temperature of 400° C., part of B is replaced with F, and Nd₂Fe₁₉(B, F) or Nd₂Fe₁₇₊ₙ(B, F) grow (n is 0 to 10). At the same time, regular phases of Fe₁₆F₂, Fe₁₆(F, C)₂, Fe₁₆(F, N)₂, Fe₁₆(F, H)₂ and the like having a lattice volume of 0.15 to 0.25 nm³ grow on the Fe-rich phase having a bcc structure or a bct structure, and part of the Nd-rich phase of an fcc structure becomes acid fluorides of the fcc structure. The cooling speed after heating and holding is set at 1° C./min, whereby some of B atoms and F atoms are regularly arranged, and Fe₁₆(F, B)₂ and the like grow.

Like this, in the magnetic particles or crystal grains, the phases in which at least two elements of fluorine, oxygen, nitrogen and boron are regularly arranged are formed in part of the main phase or the grain boundary phase. It is analyzed from the diffraction experiment that the growth of the regular phases like this contributes to increase in the residual magnetic-flux density and increase of a coercive force, and has the lattice constant about twice as large as the iron of the bcc structure, and it is found out that the value of the lattice constant is in the range of 0.57 nm to 0.65 nm.

After the reaction ends, the magnetic particle surfaces are irradiated with fluorine ions in a low-oxygen atmosphere, the fluorine concentration at the interstitial site is further made high, and the magnetic moment is increased by about 3%. The irradiation amount is 5×10¹⁶/cm². During irradiation, the position of the magnetic particles is changed, and the 20% or larger of the surface area with respect to the entire magnetic particle surface is irradiated, the lattice constants differ in the magnetic particle inner portion (center portion) and the surfaces, and the inner portion has a smaller lattice constant. More specifically, the lattice volume is large in the vicinity of the magnetic particle surfaces or the grain boundaries, the lattice volume of the inner portion shows the tendency to be smaller than the vicinity of the grain boundaries and the surfaces. More specifically, the magnetic particle inner portion with a low fluorine concentration shows the tendency to have smaller lattice volumes of the matrix phase and ferromagnetic iron. Irradiation may be performed a plurality of times by changing the irradiation amount and the irradiation energy. The fluorine concentration after irradiation becomes the maximum at the depth of 0.1 to 3 μm in the magnetic particle center direction from the magnetic particle surfaces rather than on the magnetic particle outermost surfaces. In order to enhance anisotropy during the irradiation, a magnetic field of 5 T may be applied. F is replaced with B, and thereby, the c-axes of the main phase and the Fe-rich phase extend, whereby the lattice volumes of the tetragonal crystal expand, and the magnetic moment of Fe increases by about 5%.

Further, some of N atoms or F atoms are disposed at the sites different from the interstitial sites before the reaction. The number of fluorine atoms disposed at the interstitial sites is larger than the number of fluorine atoms disposed at the atomic sites other than the interstitial sites, the atomic disposition at the sites other than the interstitial sites forms compounds with a rare-earth element and iron which differ from that of the main phase. The magnetic particles containing Nd₂Fe₁₉(B, F) like this contain 1 at % to 3 at % of fluorine, and show the magnetic properties of a Curie temperature of 480° C. (1% of fluorine) to 530° C. (3% of fluorine), and a saturation magnetic-flux density of 1.7 (1% of fluorine) to 1.8 T (3% of fluorine), and the magnetic particles are molded in an ammonium hydrogen fluoride atmosphere at 600° C. by heating, whereby a magnet with a residual magnetic-flux density of 1.7 T can be produced. The increase of the magnetic moment of iron by the regular arrangement of the elements disposed in the above described interstitial sites contributes to the increase of the residual magnetic-flux density. The fluorine atoms disposed at the interstitial sites of the octahedral position or the tetrahedral position enlarge the distance between ferromagnetic iron atoms, and the crystal magnetic anisotropy is increased by the anisotropic arrangement of the interstitial sites. Therefore, a magnet with a high energy product from 45 MGOe to 65 MGOe can be obtained. In order to enhance corrosion resistance and thermal stability of the fluorine-containing magnets, plating, coating, resin covering treatment or the like is applied to the magnet, and the magnet is applied to various magnetic circuits. Increase of the magneto crystalline anisotropy, the Curie temperature and magnetization also can be achieved by introduction of chlorine to the interstitial sites.

### Example 12

Ammonium hydrogen fluoride particles of 100 g are mixed into particles of 200 g containing Nd₁Fe₁₉ with a particle size of 1 μm as a main phase. The mixed particles are loaded in a vessel which does not directly react with magnetic particles and heated with an external heater. The ammonium hydrogen fluoride is thermally decomposed by heating, and NH₃ and fluorine-containing gas are generated. The oxide phase on the aforesaid magnetic particle surfaces is removed by the gas generation, and the oxygen concentration becomes 50 ppm. At 600° C., F (fluorine) starts to be disposed in the interstitial sites in the magnetic particles by a fluorine-containing gas. In the case of a heating temperature of 600° C., part of Fe is replaced with F, and FeF₂ or FeF₃ grows. At the same time, regular phases of Fe₁₆F₂, Fe₁₆(F, C)₂, Fe₁₆(F, N)₂, and the like having a lattice volume of 0.15 to 0.25 nm³ grow on the Fe-rich phase having a bcc structure or a bct structure, and some of the fluorides become acid fluorides of an fcc structure. The cooling speed after heating and holding is set at 1° C./min, whereby some of F atoms are regularly arranged, and Fe₁₆(F, N)₂ and the like easily grow.

Like this, in the magnetic particles or crystal grains, the phases in which at least two elements of fluorine, oxygen, nitrogen and carbon are regularly arranged are formed in part of the main phase or part of the grain boundary phase. The growth of the regular phases like this contributes to increase in the residual magnetic-flux density and increase of a coercive force. F is disposed in the interstitial sites, and thereby, the axes of an Nd₁Fe₁₉F₁₋₃ which is the main phase and the Fe-rich phase extend anisotropically, the lattice volumes of the tetragonal crystal and hexagonal crystal expand, and the magnetic moment of Fe increases by about 5%. Further, some of N or F atoms are disposed at positions different from the interstitial site before reaction. The number of fluorine atoms disposed at the interstitial sites is larger than the number of fluorine atoms disposed at the atomic sites other than the interstitial sites, and the atomic disposition at the sites other than the interstitial sites forms compounds with iron which differ from that of the main phase. The magnetic particles containing Nd₁Fe₁₉(B, F)₁₋₃ or Nd₁Fe₁₉F₁₋₃ like this show the magnetic properties of a Curie temperature of 530° C., and a saturation magnetic-flux density of 1.8 T, and the magnetic particles are heated at 1000° C. in an ammonium hydrogen fluoride atmosphere, whereby a magnet with a residual magnetic-flux density of 1.7 T can be produced by sintering. The increase of the magnetic moment of iron by the regular arrangement of the elements disposed in the above described interstitial sites contributes to the increase of the residual magnetic-flux density. The fluorine atoms disposed at the interstitial sites of the octahedral position or the tetrahedral position enlarge the distance between iron atoms, and the crystal magnetic anisotropy is increased by the anisotropic arrangement of the interstitial sites.

Further, some of fluorides in which fluorine is not arranged interstitially in the vicinity of the grain boundaries contribute to a high coercive force by antiferromagnetic coupling with the matrix phase, and therefore, a magnet with a high energy product of 55 MGOe to 70 MGOe can be obtained. The antiferromagnetic coupling like this depends on the direction of application of a magnetic field at the time of thermal treatment or at the time of magnetization, and a bilaterally asymmetrical component is seen in the demagnetizing curve. The asymmetrical component disappears by heating to a temperature lower than a Curie point.

### Example 13

The particles of 200 g with Sm₂Fe₁₇N₃ with a particle size of 5 μm as a main phase are mixed into an alcohol solution of 200 cc having the composition of PrF₃, and are put into a stainless steel vessel, and fluorine is taken into the Sm₂Fe₁₇N₃ main phase by mechanical alloying by using stainless steel balls. It is confirmed that after 30 hours of mechanical alloying, fluorine is taken into the main phase by mass spectrometry. The fluorine concentrations differ in the center and the outside of the particles, the fluorine concentration is higher in the outside, and the average fluorine concentration of the entire particles is 5 to 10 at %. The concentration depends on the concentration of PrF₃ in alcohol, and the ball diameter, the volume ratio of the balls and the particles, the rotational speed, the kind of the solvent, and the impurities in the solvent which are the mechanical alloying conditions.

The fluorine atoms form not only the interstitial sites but also the replacement sites and acid fluorides, and any of the following effects can be confirmed by introduction of fluorine of a concentration of 0.1 at % or more: 1) increase in the internal magnetic field; 2) increase in magneto crystalline anisotropy; 3) change of the direction of magnetic anisotropy; 4) increase in electric resistance; 5) change of the temperature coefficient of the saturation magnetic-flux density; 6) change of the magnetic resistance, 7) change of the heat quantity accompanying phase transition; and 8) phase transition related to movement of an atomic site of fluorine when heating the magnetic particles to a Curie temperature or higher, and the like.

The crystal structure of a magnetic substance in which some of fluorine atoms are disposed in the interstitial sites as described above is of a metastable phase, and therefore, transitions to a stable phase occur by heating. A plurality of phase transitions occur, and at least one phase transition progresses at 300° C. to 600° C. In order to set the phase transition temperature to a high temperature side, it is effective to form an ordered main phase with the elements disposed in the other interstitial sites, add a plurality of rare-earth elements, and form fluorides or acid fluorides conforming to a regular phase in the grain boundaries, and by these methods, the phase transition temperature and the Curie temperature can be made substantially the same.

Further, after iron of a bcc structure or a bct structure is grown by vacuum heat treatment at 500° C. in particles with Sm₂Fe₁₇N₃ as a main phase, the iron is mechanically ironed by using a solvent in which the fluorides as described above are swelled, whereby Fe₈F, Fe₁₆F₂, Fe₄F, Fe₃F, Fe₂F and fluorides in which nitrogen, carbon or oxygen is disposed in some of them are formed. In these fluorides, Fe₈F and Fe₁₆F₂ each have a bct structure, and in Fe₁₆F₂, the period of about twice as long as that of Fe₈F is observed by electron beam diffraction and X-ray diffraction pattern. It is found out that the period about twice as long as that of Fe₈F is in the range of the lattice constant analyzed from the diffraction experiment of 0.57 nm to 0.65 nm. Further, Fe₄F has the structure close to fcc, and these three compounds show ferromagnetism, and have the value of the magnetic moment exceeding 2.5 Bohr magnetons at 20° C., and therefore, the magnetic-flux density increases. Though in a very small amount, the fluorides in which impurities such as oxygen mixes in Fe₃F and Fe₂F grow. Fe₈F, Fe₁₆F₂ and Fe₄F which are the above described ferromagnetic compounds are grown in the high-coercive magnetic material, whereby in the magnetic material, the residual magnetic-flux density can be increased by exchange coupling with the matrix phase, and in the soft magnetic material, the saturation magnetic-flux density can be increased. As compared with Fe of bcc, the FeₙFₘ compound (n and m are positive integers) in which the unit cell volume is expanded can realize the effects of increase of anisotropic energy and increase of the coercive force by change of exchange coupling to antiferromagnetism from ferromagnetism in addition to increase of the magnetic moment, and can make the high residual magnetic-flux density and high coercive force compatible.

### Example 14

The particles of 200 g with NdFe₁₁Ti with a particle size of 1 μm as a main phase are mixed into an alcohol solution of 200 cc having the composition of NdF₃, and are put into a stainless steel vessel, and fluorine is taken into the NdFe₁₁Ti main phase by mechanical alloying by using stainless steel balls. It is confirmed that after 100 hours of mechanical alloying, fluorine is taken into the main phase by mass spectrometry. The fluorine concentrations differ in the center and the outside of the particles, the fluorine concentration in the outside shows the tendency to be higher. The concentration of NdF₃ in alcohol, and the ball diameter, the volume ratio of the balls and the particles, the rotational speed, the kind of the solvent, and the impurities in the solvent which are the mechanical alloying conditions are regulated so that the average composition becomes NdFe₁₁TiF_{0.1}. The fluorine atoms form not only the interstitial sites but also the replacement sites and acid fluorides, and the lattice constant of the body-centered tetragonal crystal shows the tendency to increase. The lattice constant of the body-centered tetragonal crystal and the Curie point of the main phase are shown in numbers 1 and 2 of Table 1. The lattice constant is expressed by an a-axis and a c-axis because of the body-centered tetragonal crystal, and unit is angstrom. Further, the Curie point is expressed by Tc, and unit is K (kelvin). The length of the c-axis is extended from 4.91 to 4.95 A (angstrom) by fluorine introduction, and the unit cell volume is increased. With this, the Tc rises to 558 K from 547 K.

In the Ndfe₁₁Tif_{0.2} produced by making the mechanical alloying time to 200 hours in the above described conditions, the c-axis is further extended and Tc rises. In the system with part of Nd replaced with Pr (number 4), the system with part of Fe replaced with Co (number 5), the system with Al added (number 6), the system with carbon (C) further added (numbers 7 and 8), extension of the c-axis and the Tc rising effect can be confirmed. The phases which is formed other than the body-centered tetragonal crystal of the main phase have the structures other than tetragonal crystal such as fluorides, acid fluorides and Nd₃Fe₂₉ of cubic crystal and rhombohedral crystal, and the volume of the phases other than the main phase is 20 volume % or less with respect to the main phase, some of the phases other than the main phase have conformity in the interface with the main phase, stabilize the crystal structure of the main phase, and the rate is necessary for making the residual magnetic-flux density of 1.2 T or higher and the coercive force of 10 kOe or higher. The lattice constant and the value of Tc with respect to the material system other than Ndfe₁₁Ti are shown in numbers 9 to 59 of Table 1. As compared with the lattice constant and Tc of the main phase into which fluorine is not introduced, Tc rises by fluorine introduction. Further, the c-axis increases with respect to any main phase. It can be estimated that the reason why the c-axis extends is some of fluorine atoms penetrate into gaps of the structure constituted of a rare-earth element and iron atoms, and because the crystal magnetic anisotropic energy increases by the c-axis extending, the coercive force also can be increased.

Further, some of fluorine atoms form a compound which is not disposed in an interstitial site, and fluorides and acid fluorides grow in the vicinity of grain boundaries. In SmFe₁₁TiF_{0.1} (number 10) obtained by adding fluorine to SmFe₁₁Ti (number 9), the Curie temperature rises, and Al is further added thereto and in SmFe₁₁TiAl_{0.01} (number 11), the Curie temperature becomes 621 K. It is conceivable that by addition of Ti and Al, the crystal structure of SmFe₁₁Ti is stabilized. In SmFe₁₂MnF_{0.1} (number 15), part of fluorine is disposed at an interstitial site. In SmFe₁₃MnF_{0.5} (number 16), anisotropy is seen in arrangement of fluorine. In SmFe₁₅MnF_{1.1} (number 17), fluorine is arranged between some of the atoms between Sm—Fe, Fe—Fe and Fe—Mn, and a local lattice distortion occurs, as a result of which, the Curie temperature rises. Swelling of the lattice due to introduction of similar lattice distortion is seen in fluorine-containing compounds of the material compositions of number 18 to number 59. At least one axial length of the lattice constant of the main phase fluorine compound shown in Table 1 is longer than the longest axial length of the lattice constant of ferromagnetic iron containing fluorine. Further, the lattice volume of the main phase is larger than 250 cubic angstroms, and is larger than 23.6 to 220 cubic angstroms which is the lattice volume of ferromagnetic iron containing fluorine. In the main phase, the lattice volume thereof expands in one direction or isotropically due to penetration of fluorine, and increase of magneto crystalline anisotropy, rise in the Curie temperature and increase of magnetization is considered to be realized by change of the electron state density distribution by the high electric negative degree of fluorine atoms.

TABLE 1

| | | a-axis | c-axis | Tc |
|---|---|---|---|---|
| No. | Compound | (A) | (A) | (K) |
| 1 | NdFe₁₁Ti | 8.57 | 4.91 | 547 |
| 2 | NdFe₁₁TiF_{0.1} | 8.57 | 4.95 | 558 |
| 3 | NdFe₁₁TiF_{0.2} | 8.58 | 4.96 | 561 |
| 4 | Nd_{0.9}Pr_{0.1}Fe₁₁TiF_{0.1} | 8.59 | 4.97 | 565 |
| 5 | Nd_{0.9}Pr_{0.1}(Fe_{0.9}Co_{0.1})₁₁TiF_{0.1} | 8.61 | 5.02 | 610 |
| 6 | Nd_{0.9}Pr_{0.1}(Fe_{0.9}Co_{0.1})₁₁TiAl_{0.01}F_{0.1} | 8.61 | 5.06 | 675 |
| 7 | Nd_{0.9}Pr_{0.1}(Fe_{0.9}Co_{0.1})₁₁TiAl_{0.01}F_{0.1}C_{0.01} | 3.62 | 5.09 | 681 |
| 8 | Nd_{0.9}Pr_{0.1}(Fe_{0.9}Co_{0.1})₁₂TiAl_{0.01}F_{0.1}C_{0.01} | 8.63 | 5.11 | 715 |
| 9 | SmFe₁₁Ti | 8.56 | 4.8 | 584 |
| 10 | SmFe₁₁TiF_{0.1} | 8.57 | 4.85 | 595 |
| 11 | SmFe₁₁TiAl_{0.01}F_{0.1} | 8.57 | 5.21 | 621 |
| 12 | SmFe₁₁Ti_{0.1}Al_{0.01}F | 8.59 | 5.35 | 635 |
| 13 | SmFe₁₁Ti_{0.1}Al_{0.01}F₂ | 8.61 | 5.41 | 641 |
| 14 | SmFe₁₁Ti_{0.1}Al_{0.01}F₂C_{0.1} | 8.69 | 5.56 | 662 |
| 15 | SmFe₁₂MnF_{0.1} | 8.71 | 5.68 | 673 |
| 16 | SmFe₁₃MnF_{0.5} | 8.71 | 5.69 | 685 |
| 17 | SmFe₁₅MnF_{1.1} | 8.72 | 5.75 | 695 |
| 18 | DyFe₁₁Ti | 8.52 | 4.8 | 534 |
| 19 | DyFe₁₁TiF_{0.1} | 8.53 | 4.95 | 635 |
| 20 | LuFe₁₁Ti | 8.46 | 4.77 | 488 |
| 21 | LuFe₁₁TiF_{0.1} | 8.47 | 4.79 | 525 |
| 22 | SmFe_{10.8}Ti_{1.2} | 8.56 | 4.79 | 585 |
| 23 | SmFe_{10.8}Ti_{1.2}F_{0.1} | 8.55 | 5.15 | 685 |
| 24 | SmFe_{10.5}Al_{0.5}Ti | 8.55 | 4.79 | 588 |
| 25 | SmFe_{10.5}Al_{0.5}TiF_{0.01} | 8.55 | 4.88 | 652 |
| 26 | SmFe_{10.5}Al_{0.5}TiF_{0.05} | 8.56 | 5.01 | 751 |
| 27 | SmFe_{10.5}(Al_{0.9}Mg_{0.1})_{0.1}TiF_{0.05} | 8.57 | 5.03 | 756 |
| 28 | SmFe_{10.5}(Al_{0.9}Ca_{0.1})_{0.1}TiF_{0.05} | 8.59 | 5.03 | 771 |
| 29 | SmFe_{10.5}(Al_{0.9}Ca_{0.1})_{0.1}Ti_{0.5}F_{0.1} | 8.59 | 5.08 | 765 |
| 30 | SmFe₁₁TiN_{0.8} | 8.64 | 4.84 | 769 |
| 31 | SmFe₁₁TiN_{0.8}F_{0.05} | 8.65 | 5.38 | 795 |
| 32 | SmFe₁₁TiC_{0.8} | 8.64 | 4.81 | 698 |
| 33 | SmFe₁₁TiC_{0.8}F_{0.05} | 8.62 | 5.12 | 751 |
| 34 | SmFe₁₁AlC_{0.8}F_{0.05}H_{0.001} | 8.63 | 5.15 | 784 |
| 35 | YFe₁₁TiN_{0.8} | 8.62 | 4.81 | 733 |
| 36 | YFe₁₁TiN_{0.5}F_{0.05} | 8.63 | 5.12 | 785 |
| 37 | CeFe₁₀V₂ | 8.5 | 4.75 | 440 |
| 38 | CeFe₁₀V₂F_{0.05} | 8.48 | 4.78 | 451 |
| 39 | CeFe₁₀(V_{0.9}Al_{0.1})₂F_{0.05} | 8.49 | 5.12 | 512 |
| 40 | CeFe₁₀(V_{0.9}Al_{0.1})₂F_{0.05}C_{0.01} | 8.49 | 5.18 | 608 |
| 41 | SmFe₁₀V_{1.8} | 8.53 | 4.77 | 605 |
| 42 | SmFe₁₀V_{1.8}F_{0.1} | 8.54 | 5.05 | 705 |
| 43 | SmFe₈Co₂Si₂ | 8.45 | 4.74 | 714 |
| 44 | SmFe₈Co₂Si₂F_{0.1} | 8.44 | 5.05 | 725 |
| 45 | SmFe₅Co₅Si₂ | 8.42 | 4.71 | 845 |
| 46 | SmFe₅Co₅Si₂F_{0.1} | 8.43 | 5.09 | 868 |
| 47 | SmFe₁₀Cr₂ | 8.5 | 4.76 | 562 |
| 48 | SmFe₁₀Cr₂F_{0.05} | 8.53 | 4.95 | 652 |
| 49 | NdFe₁₀Mo_{1.8} | 8.6 | 4.79 | 395 |
| 50 | NdFe₁₀Mo_{1.8}F_{0.05} | 8.62 | 4.89 | 557 |
| 51 | SmFe₁₁Mo | 8.57 | 4.78 | 510 |
| 52 | SmFe₁₁MoF_{0.05} | 8.59 | 5.28 | 628 |
| 53 | GdFe_{8.5}Al_{3.5} | 8.56 | 4.92 | 388 |
| 54 | GdFe_{8.5}Al_{3.5}F_{0.01} | 8.57 | 5.18 | 523 |
| 55 | YFe₈Co₂Si₂ | 8.42 | 4.73 | 670 |
| 56 | YFe₈Co₂Si₂F_{0.01} | 8.43 | 4.98 | 685 |
| 57 | YFe₈Co₂Mg₂F_{0.01} | 8.44 | 5.12 | 686 |
| 58 | YFe₈Co₂Al₂F_{0.001} | 8.45 | 5.26 | 715 |
| 59 | YFe₈Co₂Al₂F_{0.005} | 8.46 | 5.29 | 725 |

### Example 15

The particles of 100 g with YFe₆Al₆ with a particle size of 0.1 μm as a main phase are mixed into an alcohol solution of 200 cc containing YF₂ crystal fluoride with a particle size of 0.01 μm, and are put into a stainless steel vessel coated with YF₂, and a metastable compound grows by diffusion of YF₂ fluorine from an YFe₆Al₆ main phase surface and reaction in the vicinity of surfaces by mechanical alloying by using stainless steel balls with a diameter of about 100 μm which is coated with YF₂. Part of fluorine forms fluorides or acid fluorides of Fe or Ce, but the particles having an oxygen concentration of 500 ppm or lower and Fe increased by 0.1 to 5 at % from the composition of YFe₆Al₆ are used so that the amount of fluorine atoms composing the above described fluorides and acid fluorides becomes smaller than the amount of fluorine atoms disposed in the interstitial sites. After mechanical alloying is performed for 100 hours, thermal treatment at 500° C. for 10 hours is tried by using the atmosphere containing 1% of fluorine. As a result, YFe₆Al₆F grows, and extension of the a-axis and the c-axis can be confirmed. Further, it is confirmed that the Curie temperature (Tc) of Yf₆Al₆F obtained from temperature dependence of magnetization rises to 389 K from the temperature (310 K) without introduction of fluorine.

The axial length increase of the c-axis and rise of the Curie point by introduction of fluorine like this can be confirmed in the iron materials which do not contain rare-earth elements other than Y, and the result thereof are shown in 10 to 117 of Table 2. By the Curie point rising, the magnetic material can be applied to magnet application products which require heat resistance (a rotor machine, a hard disk, a magnetic resonance apparatus and the like) as a sintered magnet and a bond magnet. Further, in the SmMn₄Al₃ compound which does not contain Fe, thermal treatment at 500° C. is carried out for 10 hours in a fluorine gas atmosphere, whereby fluorine is introduced. By the fluorinating treatment, the axial lengths of the a-axis and the c-axis are increased, and the Curie point rises. The results thereof are shown in 119 to 123 of Table 2. The crystal magnetic anisotropy energy is increased by about 10 to 50% by fluorine introduction, the direction and magnitude of the magnetic anisotropy are changed. The fluorine introduction like this increases the distance between Mn atoms by 10% from 0.1, and spins of some of Mn atoms are ferromagnetically coupled. Further, increase in the distance between Mn atoms like this increases the magnetic thermal amount effect, and can be applied to magnetic refrigeration materials.

TABLE 2

| | | a-axis | c-axis | |
|---|---|---|---|---|
| No. | Compound | (A) | (A) | Tc(K) |
| 101 | YFe₆Al₆ | 8.65 | 4.99 | 310 |
| 102 | YFe₇Al₅F | 8.66 | 5.02 | 389 |
| 103 | YFe₈Al₄F | 8.51 | 5.09 | 385 |
| 104 | YFe₉Al₂F_{0.5}C_{0.5} | 8.68 | 5.01 | 456 |
| 105 | YFe₉Al₂F_{0.75}C_{0.5} | 8.67 | 5.05 | 475 |
| 106 | YFe₉Al₂FC_{0.2} | 8.67 | 5.12 | 485 |
| 107 | YFe₉Al₂F_{1.2}C_{0.5} | 8.65 | 5.15 | 491 |
| 108 | YFe₉Al₂F₂C_{0.1} | 8.66 | 5.16 | 512 |
| 109 | YFe₉Al₂F_{0.5}N_{0.5} | 8.69 | 5.21 | 563 |
| 110 | YFe₉Al₂F_{0.5}N_{0.7} | 8.68 | 5.25 | 569 |
| 111 | YFe₉Al₂F_{0.4}N_{0.9} | 8.69 | 5.28 | 611 |
| 112 | YFe₉Al₂F_{0.3}N_{0.8} | 8.71 | 5.31 | 615 |
| 113 | YFe₉Al₂F_{0.1}N_{0.5} | 8.73 | 5.35 | 625 |
| 114 | YFe₉Al₂F_{0.1}N_{0.9} | 8.76 | 5.39 | 635 |
| 115 | YFe₉(Al_{0.9}Mg_{0.1})₂F₂C_{0.1} | 8.78 | 5.41 | 715 |
| 116 | YFe₉(Al_{0.9}Ca_{0.1})₂F₂C_{0.1} | 8.79 | 5.45 | 752 |
| 117 | YFe₉(Al_{0.9}Ca_{0.1})₂NF_{0.5}C_{0.1} | 8.81 | 5.56 | 756 |
| 118 | SmMn₄Al₈ | 8.9 | 5.12 | 12 |
| 119 | SmMn₄Al₈F_{0.1} | 8.91 | 5.19 | 126 |
| 120 | SmMn₄Al₈F_{0.2} | 8.95 | 5.25 | 138 |
| 121 | SmMn₄Al₈F_{0.5} | 8.97 | 5.31 | 215 |
| 122 | SmMn₄Al₅F_{0.1} | 9.02 | 5.36 | 235 |
| 123 | SmMn₄Al₂F_{0.5} | 9.05 | 5.41 | 320 |

### Example 16

The particles of 100 g with Ce₂Fe₁₇C with a particle size of 1 μm as a main phase are mixed into an amorphous fluoride alcohol solution of 200 cc with the composition of CeF₂, and are put into a stainless steel vessel coated with a fluoride, and a metastable compound grows by diffusion of fluorine of CeF₂ from a Ce₂Fe₁₇C main phase surface and reaction in the vicinity of the surfaces by mechanical alloying by using stainless steel balls with a diameter of about 100 μm which is coated with a fluoride. Part of fluorine forms fluorides or acid fluorides with Fe or Ce, but the particles having an oxygen concentration of 1000 ppm or lower and Fe increased by 0.1 to 5 at % are used so that the amount of fluorine atoms composing the above described fluorides and acid fluorides becomes smaller than the amount of fluorine atoms disposed in the interstitial sites. After mechanical alloying is performed for 100 hours, thermal treatment at 400° C. for 10 hours is tried by using the atmosphere containing 1% of fluorine. As a result, Ce₂Fe₁₇CF_{0.1} grows, and extension of the lattice constant can be confirmed. Further, it is confirmed that the Curie temperature (Tc) of Ce₂Fe₁₇CF_{0.1} obtained from temperature dependence of magnetization rises to 412 K from the temperature (297 K) without introduction of fluorine.

The axial length increase of the lattice constant and rise of the Curie point by introduction of fluorine like this can be confirmed in the other rare-earth materials, and the result thereof is shown in Table 3. By the Curie point rising, the magnetic material can be applied to magnet application products which require heat resistance (a rotor machine, a hard disk, a magnetic resonance apparatus and the like) as a sintered magnet and a bond magnet.

TABLE 3

| | | a-axis | c-axis | Tc |
|---|---|---|---|---|
| No. | Compound | (A) | (A) | (K) |
| 200 | Ce₂Fe₁₇C | 8.53 | 12.43 | 297 |
| 201 | Ce₂Fe₁₇CF_{0.1} | 8.54 | 12.48 | 412 |
| 202 | Pr₂Fe₁₇C | 8.62 | 12.48 | 370 |
| 203 | Pr₂Fe₁₇CF_{0.1} | 8.63 | 12.51 | 413 |
| 204 | Pr₂Fe₁₇CF_{0.2} | 8.64 | 12.56 | 452 |
| 205 | Sm₂Fe₁₇C | 8.56 | 12.45 | 552 |
| 206 | Sm₂Fe₁₇CF_{0.1} | 8.57 | 12.52 | 635 |
| 207 | Gd₂Fe₁₇C | 8.56 | 12.5 | 582 |
| 208 | Gd₂Fe₁₇CF_{0.1} | 8.57 | 12.71 | 653 |
| 209 | Tb₂Fe₁₇C | 8.57 | 12.85 | 595 |
| 210 | Tb₂Fe₁₇CF_{0.1} | 8.56 | 12.91 | 625 |
| 211 | Y₂Fe₁₇C | 8.57 | 12.5 | 501 |
| 212 | Y₂Fe₁₇CF_{0.1} | 8.57 | 12.63 | 631 |
| 213 | Y₂Fe₁₇CHF_{0.1} | 8.58 | 12.65 | 638 |
| 214 | Ce₂Fe₁₇N₃ | 8.73 | 12.65 | 713 |
| 215 | Ce₂Fe₁₇N₂F | 8.72 | 12.85 | 793 |
| 216 | Ce₂Fe₁₇N₁F₂ | 8.71 | 12.91 | 810 |
| 217 | Pr₂Fe₁₇N₃ | 8.77 | 12.64 | 725 |
| 218 | Pr₂Fe₁₇N₂F | 8.75 | 12.81 | 852 |
| 219 | Nd₂Fe₁₇N₃ | 8.76 | 12.62 | 731 |
| 220 | Nd₂Fe₁₇N₂F | 8.77 | 12.85 | 795 |
| 221 | Nd₂Fe₁₇NF₂ | 8.71 | 12.91 | 825 |
| 222 | Sm₂Fe₁₇N_{2.3} | 8.73 | 12.63 | 746 |
| 223 | Sm₂Fe₁₇N₂F_{0.1} | 8.73 | 12.69 | 758 |
| 224 | Sm₂Fe₁₇N₂F_{0.2} | 8.74 | 12.71 | 761 |
| 225 | Sm₂Fe₁₇N₂F_{0.3} | 8.74 | 12.75 | 765 |
| 226 | Sm₂Fe₁₇N₂F_{0.4} | 8.75 | 12.81 | 773 |
| 227 | Sm₂Fe₁₇N₂F_{0.5} | 8.76 | 12.88 | 781 |
| 228 | Sm₂Fe₁₇N₂F_{0.6} | 8.76 | 12.91 | 795 |
| 229 | Sm₂Fe₁₇N₂F_{0.6}H_{0.1} | 8.76 | 12.92 | 810 |
| 230 | Sm₂Fe₁₇N₂F_{0.6}H_{0.1}C_{0.1} | 8.76 | 12.95 | 810 |
| 231 | Pr₂Fe₁₇N₂ | 8.71 | 12.59 | 732 |
| 232 | Pr₂Fe₁₇N₂F_{0.1} | 8.71 | 12.85 | 852 |
| 233 | La₂Fe₁₇N₂ | 8.69 | 12.85 | 710 |
| 234 | La₂Fe₁₇N₂F_{0.1} | 8.69 | 12.91 | 775 |
| 235 | La₂(Fe_{0.9}Mn_{0.1})₁₇N₂ | 8.65 | 12.48 | 695 |
| 236 | La₂(Fe_{0.9}Mn_{0.1})₁₇N₂F_{0.2} | 9.62 | 12.85 | 775 |
| 237 | Sm₂Fe₁₉N_{2.3} | 8.62 | 12.93 | 690 |
| 238 | Sm₂Fe₁₉N₂F_{0.1} | 8.62 | 12.95 | 702 |
| 239 | Sm₂Fe₁₉N₂F_{0.2} | 8.61 | 12.96 | 710 |
| 240 | Sm₂Fe₁₉N₂F_{0.3} | 8.61 | 12.97 | 720 |
| 241 | Sm₂Fe₁₉N₂F_{0.4} | 8.62 | 12.99 | 710 |
| 242 | Sm₂Fe₁₉N₂F_{0.5} | 8.63 | 13.02 | 715 |
| 243 | Sm₂Fe₁₉N₂F_{0.6} | 8.63 | 13.05 | 710 |
| 244 | Sm₂Fe₂₃N_{2.3} | 8.63 | 12.98 | 685 |
| 245 | Sm₂Fe₂₃N₂F_{0.1} | 8.61 | 13.02 | 695 |
| 246 | Sm₂Fe₂₃N₂F_{0.2} | 8.59 | 13.05 | 700 |
| 247 | Sm₂Fe₂₃N₂F_{0.3} | 8.59 | 13.06 | 702 |
| 248 | Sm₂Fe₂₃N₂F_{0.4} | 8.58 | 13.08 | 705 |
| 249 | Sm₂Fe₂₃N₂F_{0.5} | 8.57 | 13.07 | 710 |
| 250 | Sm₂Fe₂₃N₂F_{0.6} | 8.56 | 13.07 | 715 |
| 251 | SmFe₂₄Mo | 8.59 | 13.02 | 712 |
| 252 | SmFe₂₄MoF_{0.05} | 8.57 | 13.15 | 758 |
| 253 | SmFe₂₄Ti | 8.61 | 13.05 | 715 |
| 254 | SmFe₂₄TiF_{0.05} | 8.6 | 13.15 | 721 |

### Example 17

Particles of 100 g with La₂Fe₁₇N with a particle size of 100 μm as a main phase are mixed into an amorphous fluoride alcohol solution of 100 cc with the composition of LaF₂, and are put into a stainless steel vessel coated with a fluoride, and a metastable compound grows by diffusion of fluorine of LaF₂ from a La₂Fe₁₇N main phase surface and reaction in the vicinity of the surfaces by mechanical alloying by using stainless steel balls with a diameter of about 100 μm which is coated with a fluoride. Part of fluorine forms fluorides or acid fluorides with Fe or La, but the concentration of fluorine atoms which compose the above described fluorides and acid fluorides is higher than the concentration of fluorine atoms which are disposed in the interstitial sites of the matrix phase.

The high fluorine concentration compound like this is nonmagnetic, but becomes a fluorine supply source to a matrix phase and has a reduction effect of removing oxygen in the matrix phase at the same time. Therefore, the magneto crystalline anisotropy increases, and the Curie temperature becomes high. Further, by using the particles in which the Fe composition is increased by 5 at % from 0.1, an Fe—F binary alloy having a lower fluorine concentration than the matrix phase is formed, whereby rise of the residual magnetic-flux density from 0.1 to 0.2 T by ferromagnetic coupling of the matrix phase and the Fe—F binary alloy can be realized. After mechanical alloying is performed for 100 hours, thermal treatment at 400° C. for 10 hours is performed and rapid cooling from 400° C. to a room temperature is tried by using the atmosphere containing 1% of fluorine. As a result, La₂Fe₁₇NF_{0.1} grows, and extension of the c-axis can be confirmed. Further, it is confirmed that the Curie temperature (Tc) of Ce₂Fe₁₇NF_{0.1} obtained from temperature dependence of magnetization rises to 452 K from the temperature (321 K) without introduction of fluorine. The axial length increase of the c-axis and rise of the Curie point by introduction of fluorine like this can be confirmed in the material particles in which fluorine is introduced into the other rare-earth iron nitrogen materials, the materials in which fluorine is introduced into a rare-earth iron carbon material or a transition metal fluoride.

In any of the materials, the phase in which fluorine atoms are in interstitial sites is a main phase, and the main phase volume is larger than other fluorine replaced phases or acid fluorides. By the Curie point rising, the magnetic material can be applied to magnet application products which require heat resistance (a rotor machine, a hard disk, a magnetic resonance apparatus and the like) as a sintered magnet and a bond magnet. In a sintered magnet, a fluorine compound with a different crystal structure from the main phase grow in some of the grain boundaries. Acid fluorides containing oxygen grow in part of triple point of the grain boundaries. Further, in a bond magnet, oxides, fluorides or acid fluorides other than organic materials can be used for binder, and by adopting an inorganic binder, heat resistance of the magnet is enhanced.

### Example 18

After an iron foil substance of a thickness of 100 nm is coated with an Sm—F solution, the iron foil substance is thermally treated. The purity of the iron foil substance is 99.8%. Since the Sm—F solution shows an amorphous structure, an X-ray diffraction pattern differs from the pattern of a crystal substance, and one or more peaks of a half value width of one degree or more are included. After the iron foil substance is coated with a solution of 0.1 wt %, the iron foil substance is heated and held at 600° C. for 10 hours in an atmosphere in which ammonium fluoride is evaporated, and thereafter, the iron foil substance is rapidly cooled. By the treatment, the iron foil and the fluoride react with each other, and the iron foil containing Sm and fluorine is obtained. When the iron foil is thermally treated at a higher temperature than 600° C., fluorine hardly forms an iron rare-earth fluorine ternary compound, stable fluorides and acid fluorides grow, and enhancement of magnetic properties becomes difficult.

When thermal treatment is performed at 600° C., Sm₂Fe₁₇Fx (x=1 to 3) and SmOF and SmF₃ grow in the iron foil, and a foil substance having a structure in which hexagonal crystal and cubic crystal are mixed is obtained. When hexagonal crystal is a main phase, and fluorine is disposed in the interstitial sites or replacement sites, the coercive force becomes 20 to 25 kOe, and the Curie temperature becomes 400 to 600° C. The iron foil substance showing soft magnetism like this can be changed to a hard magnetic material by the above described process. The above described treatment can cause the iron foil substance to have hard magnetic properties locally by using a mask material. The suitable number of iron foil substances produced in the present process are properly stacked, and can be made a magnetic substance. The space between iron atoms is uniformly extended by penetration of fluorine in part of iron, whereby tetragonal crystal is formed, the saturation magnetic-flux density can be increased to 2.1 to 2.5 T, a magnet in which a high saturation magnetic-flux density material and a high magnetic anisotropic material having different crystal structures have ferromagnetic coupling in the same magnetic substance is obtained, an iron foil substance and a stacked substance having both a high residual magnetic-flux density (1.5 T to 1.9 T) of a magnet and a high magnetic-flux densification of soft magnetic iron locally can be obtained. The stacked substance is used for a rotating machine and a voice coil motor, whereby contribution can be made to reduction in size and weight of components.

### Example 19

Particles of 100 g with NdFe₁₁Ti with a particle size of 100 nm as a main phase are mixed into an alcohol solution of 100 cc containing 10 wt % of pulverized powder of NdF₃, are put into a stainless steel vessel with fluorides coated and diffused thereon, and are heated and reduced in a hydrogen atmosphere, after which, fluorine is taken in an NdFe₁₁Ti main phase by mechanical alloying by using stainless balls with fluorides formed on the surface by fluoride surface treatment. It is confirmed by mass spectrometry that after 200 hours of mechanical alloying, fluorine is taken into the main phase. The fluorine concentration differs in the center and the outside of the particle, and shows tendency to be higher at the outside. The concentration of NdF₃ in alcohol, the ball diameter, the volume ratio of the balls and particles, the rotational speed, the kind of solvents, and impurities in the solvent are regulated so that the average composition becomes NdFe₁₁TiF₁. Fluorine atoms form not only the interstitial sites but also the replacement sites of hexagonal crystal and acid fluorides, the lattice constant of the body-centered tetragonal crystal shows the tendency to increase. The obtained particles are further heated at 400° C. in ammonium fluoride gas, whereby fluorination further progresses, NdFe₁₁TiF₂ and NdFe₁₁TiF₃ grow, the fluorine has the concentration higher than a rare-earth element, and part of fluorine forms a rare-earth fluoride and a rare-earth acid fluoride, or an iron fluoride and an iron acid fluoride other than the matrix phase.

The mechanical alloying conditions and the crystal particle size are adjusted so that the phases other than the main phase are of volume % within the range of 0.1 to 20 volume %. As the phases other than the main phase, a ferromagnetic tetragonal crystal Fe—F binary alloy phase grows, whereby the residual magnetic-flux density can be increased. The ferromagnetic iron fluorine alloy and the fluorine-containing phases other than the main phase are desirably of 0.1 to 10 volume %. The hardness of the fluorine-containing phases other than the main phase reduces at 400° C., and therefore, the particles containing the fluorine-containing phases other than the main phase is heated and molded after magnetic field orientation, whereby a molded body of density of 95 to 98% is obtained, and anisotropic magnet with a residual magnetic-flux density of 1.0 to 1.8 T and a coercive force of 15 to 40 kOe is obtained.

### Example 20

After particles with Sm₂Fe₁₇ with a particle size of 5 μm as a main phase are preformed in a magnetic field of 10 kOe, the preform is loaded into a vacuum heating device, and heated and sintered at 1200° C. for 5 hours. After sintering, ammonium fluoride gas is introduced into an aging chamber adjacent to a heating chamber at around 1000° C., and fluorine is diffused from outside the sintered body. As a result of analyzing the fluorine concentration by wavelength-dispersive X-ray spectrometry, secondary ion mass spectrometry and the like, the fluorine concentration differs in the center and the outside of the sintered body, and is higher in the outside, and the average fluorine concentration of the entire sintered body is 1 to 15 at %. The concentration depends on the partial pressure of the gas which heats and decomposes ammonium fluoride (NH₄F) and the aging fluorination temperature. Further, the concentration depends on the grain size of the particles and the density of the sintered body.

Fluorine atoms form not only the interstitial sites, but also replacement sites and acid fluorides, and any of the following effects can be confirmed by introduction of fluorine of a concentration of 0.1 at % or more: 1) increase in the internal magnetic field; 2) increase in magneto crystalline anisotropy; 3) change of the direction of magnetic anisotropy; 4) increase in electric resistance; 5) change of the temperature coefficient of the saturation magnetic-flux density; 6) change of the magnetic resistance; 7) change of the heat quantity accompanying phase transition; and 8) phase transition related to movement of an atomic site of fluorine when heating the magnetic particles to a Curie temperature or higher, and the like.

The crystal structure of a magnetic substance in which some of fluorine atoms are disposed in interstitial sites as described above is of a metastable phase, and therefore, the phase transitions to a stable phase occur by heating. A plurality of phase transitions occur, and at least one phase transition progresses at 400° C. to 900° C. After iron of a bcc structure or a bct structure is grown in the particles with Sm₂Fe₁₇ as a main phase, Fe₈F, Fe₁₆F₂, Fe₄F, Fe₃F, Fe₂F and fluorides in which nitrogen, carbon or oxygen is disposed in part of them are formed by fluorination processing as described above. In the fluorides, Fe₈F and Fe₁₆F₂ have a bct structure, and in Fe₁₆F₂, the period about twice as large as that of Fe₈F is observed by electron beam diffraction and X-ray diffraction pattern. It is found out that the period about twice as long as that of Fe₈F is in the range of the lattice constant analyzed from the diffraction experiment of 0.57 nm to 0.65 nm.

Further, Fe₄F has the structure close to fcc, and these three compounds show ferromagnetism, and have the value of the magnetic moment exceeding 2.5 Bohr magnetons at 20° C., and therefore, the magnetic-flux density increases. Though in a very small amount, the fluorides in which impurities such as oxygen are included in Fe₃F and Fe₂F grow. Fe₈F, Fe₁₆F₂ and Fe₄F which are the above described ferromagnetic compounds are grown in the high-coercive magnetic material, whereby in the magnetic material, the residual magnetic-flux density can be increased by exchange coupling with the matrix phase, and in the soft magnetic material, the saturation magnetic-flux density can be increased. As compared with Fe of bcc, the FeₙFₘ compound (n and m are positive integers) in which the unit cell volume is expanded can realize the effect of increase of anisotropic energy and increase of the coercive force by change of exchange coupling to antiferromagnetism from ferromagnetism in addition to increase of the magnetic moment, and can make the high residual magnetic-flux density and high coercive force compatible. Similar improvement of the magnetic properties can be realized by fluorinating treatment of a sintered body or a preform of ReₙFeₘ and ReₙCOₘ (Re is a rare-earth element, n and m are integers, the phases in which a plurality of metal elements other than Fe and Co are contained in the matrix phase). The magnetic properties can be ensured even if the impurities such as carbon, oxygen, hydrogen and nitrogen are mixed into the fluorides, and therefore, there is not problem in actual use.

### Example 21

After particles with Sm₂Fe₁₉ with a particle size of 1 μm as a main phase are preformed in a magnetic field of 10 kOe, the preform is loaded into a vacuum heating device, and is heated and sintered at 1100° C. for 5 hours after being reduced by hydrogen. After sintering, in order to fill an ammonium fluoride gas at around 900° C., the preform is moved to an aging chamber adjacent to the heating chamber without being exposed to an atmosphere, and fluorine is diffused from outside the sintered body. As a result of analyzing the fluorine and nitrogen concentrations by wavelength-dispersive X-ray spectrometry, secondary ion mass spectrometry and the like, the fluorine concentration differs in the center and the outside of the sintered body, and is higher in the outside, and the average fluorine concentration of the entire sintered body is 1 to 12 at %, and it is confirmed that nitrogen and hydrogen are contained in lower concentrations than the fluorine concentration. The concentrations of these elements depend on the partial pressure of the gas which heats and decomposes ammonium fluoride (NH₄F) and the aging fluorination temperature. Further, the concentrations depend on the particle size of the particles and the density of the sintered body.

Fluorine atoms form not only the interstitial sites, but also replacement sites and acid fluorides, and any of the following effects can be confirmed by introduction of fluorine in a concentration of 0.01 at % or more: 1) the internal magnetic field higher than pure iron; 2) increase in magneto crystalline anisotropy; 3) change of the direction of magneto crystalline anisotropy; 4) increase in magnetic resistance; 5) change of the temperature coefficient of the saturation magnetic-flux density; 6) increase of coercive force; 7) change of the heat quantity accompanying phase transition; and 8) phase transition related to movement of an atomic site of fluorine when heating the magnetic particles to a Curie temperature or higher, and the like. The crystal structure of a magnetic substance in which some of fluorine and nitrogen atoms are disposed in the interstitial sites as described above is of a metastable phase, and therefore, the phase transitions to a stable phase occur by heating. A plurality of phase transitions occur, and at least one phase transition progresses at 400° C. to 900° C. After iron of a bcc structure or a bct structure is grown in the particles with Sm₂Fe₁₉ as a main phase, Fe₈(F, N), Fe₁₆(F, N)₂, Fe₄(F, N), Fe₃(F, N), Fe₂(F, N) and fluorides in which nitrogen, carbon or oxygen is disposed in part of them are formed by fluorination processing as described above. In the fluorides, Fe₈(F, N) and Fe₁₆(F, N)₂ each have a bct structure, and in Fe₁₆(F, N)₂, the period about twice as large as that of Fe₈(F, N) is observed in electron beam diffraction and X-ray diffraction pattern. It is found out that the period which is about twice as long as that of Fe₈(F, N) is in the range of the lattice constant analyzed from the diffraction experiment of 0.57 nm to 0.65 nm. Further, Fe₄(F, N) has the structure close to fcc, and these three compounds show ferromagnetism, and have the value of the magnetic moment exceeding 2.5 Bohr magnetons at 20° C., and therefore, the magnetic-flux density increases.

Fe₈(F,N), Fe₁₆(F, N)₂ and Fe₄(F, N) which are the above described ferromagnetic compounds are grown in the high-coercive magnetic material, whereby in the magnetic material, the residual magnetic-flux density can be increased by exchange coupling with the matrix phase, and in the soft magnetic material, the saturation magnetic-flux density can be increased. The FeₙFₘNₗ compound (m, m and l are positive integers) in which the unit cell volume is expanded as compared with Fe of bcc can realize the effects of increase of anisotropic energy and increase of the coercive force by change of exchange coupling to antiferromagnetism from ferromagnetism in addition to increase of the magnetic moment, and can make the high residual magnetic-flux density and high coercive force compatible, and similar improvement of the magnetic properties can be realized by fluorinating treatment of a sintered body or a preform of ReₙFeₘ and ReₙCOₘ (Re is a rare-earth element, n and m are integers, the phases in which a plurality of metal elements other than Fe and Co or semimetal elements (Cu, Al, Zr, Ti, Mn, Cr, Mo, Ca, Bi, Ta, Mg, Si, B, C) are contained in the matrix phase). The magnetic properties can be ensured even if the impurities such as carbon, oxygen, hydrogen and nitrogen are included in the fluorides, and therefore, there is not problem in actual use.

### Example 22

Particles of 100 g with La(Fe_{0.9}Si_{0.1}Al_{0.01})₁₃ with a particle size of 100 nm as a main phase are mixed into an alcohol solution of 100 cc containing 10 wt % of pulverized powder of LaF₃, are put into a stainless steel vessel with fluorides coated and diffused thereon, and are heated and reduced in a hydrogen atmosphere, after which, fluorine is taken into an La(Fe_{0.9}Si_{0.1}Al_{0.01})₁₃ main phase by mechanical alloying by using stainless steel balls with fluorides formed on the surface by fluoride surface treatment. It is confirmed by mass spectrometry that after 200 hours of mechanical alloying, fluorine is taken into the main phase.

The fluorine concentration differs in the center and the outside of the particles, and shows the tendency to be higher in the outside. The concentration of LaF₃ in alcohol, the ball diameter, the volume ratio of the balls and particles, the rotational speed, the kind of solvents, and impurities in the solvent which are the mechanical alloying conditions are regulated so that the average composition becomes La(Fe_{0.9}Si_{0.1}Al_{0.01})₁₃F. Fluorine atoms form not only the interstitial sites, but also the replacement sites of the main phase and acid fluorides. The obtained particles are further heated at 400° C. in an ammonium fluoride gas, whereby fluorination further progresses, La(Fe_{0.9}Si_{0.1}Al_{0.01})₁₃F₂ and La(Fe_{0.9}Si_{0.1}Al_{0.01})₁₃F₃ grow, the fluorine has the concentration higher than a rare-earth element, and part of fluorine forms a rare-earth fluoride and a rare-earth acid fluoride, or an iron fluoride and an iron acid fluoride other than the main phase.

The mechanical alloying conditions and the crystal particle size are adjusted so that the phases other than the main phase are of volume % within the range of 0.1 to 20 volume %, and it is confirmed that magnetic entropy change increases by fluorine introduction. The fluorine-containing phase and the hard magnetic material are conjugated, and the magnetic material having the magnetism cooling effect can be produced.

### Example 23

Particles of Sm₂Fe_{17.2} are heated in a hydrogen current by using a heat treat furnace, and some of the particles are hydrogenated. The particles are pulverized by using the phenomenon that particles become brittle by containing hydrogen, and particles with an average particle size of 5 μm are obtained. Anisotropy may be added to particles by using hydrogen disproportionation recombination. The particles of 100 g are heated and held in a gas atmosphere in which ammonium fluoride NH₄F is sublimated without being exposed to an atmosphere. After being heated and held, acid fluorides and oxides which are formed on particle surfaces and the like by addition of CaH₂ are reduced. The heating temperature is in the range of 150° C. to 1000° C., and the optimal temperature is 300° C. to 700° C.

Besides the gas containing fluorine, the reduction reaction by hydrogen is advanced, and thereby, fluorination easily advances to the inside of the particles. By the treatment, Sm₂Fe_{17.1}F₁₋₃ grows with fluorine-containing iron and acid fluorides. The fluorinated particles have a matrix phase of Sm₂Fe_{17.1}F₁₋₃, and the fluorine concentration is higher in the outer peripheral sides than the center portions of the particles in the matrix phase in average. On the particle surfaces, the phases of any of oxides and acid fluorides or fluorides, which contains fluorine and are different from the main phase grow. In the above described Sm₂Fe_{17.1}F₁₋₃, ferromagnetic phases having crystal structures different from the main phase such as an Fe phase of a bcc structure, an Fe—F phase of a bct structure, SmOF, SmF₃, Fe₂O₃, Fe₃O₄, and Sm₂O₃, and a phase which has magnetization of 1/10 or lower of that of the main phase and is considered to be a weak magnetic phase or a nonmagnetic phase grow. The volume of Sm₂Fe_{17.1}F₁₋₃ with respect to the entire particles is 70 to 90%, and the volume of the ferromagnetic phase is 95%. By the above described fluorination treatment, increase of magnetization, rise of the Curie temperature (Tc), and increase of magneto crystalline anisotropy energy can be confirmed. The saturation magnetic-flux density of Sm₂Fe_{17.1}F₁₋₃ is 1.7 T, the Curie temperature is 795 K, and the crystallomagnetic anisotropic energy Ku is 15 MJ/m³.

It is confirmed that these magnetic properties change in accordance with the fluorine concentration gradient, additives, the composition of impurities and the like, fluorine atomic sites and regularity, the crystal structures including lattice constants, and the phases having the interfaces with the main phase and having the crystal structures different from that of the main phase. Increase of the saturation magnetic-flux density and the Curie temperature also can be confirmed from measurement of the temperature dependence of magnetization in the composition of Sm₂Fe_{17.1}F_{0.1}, and increase in the lattice constant by fluorine atoms also can be confirmed by X-ray diffraction pattern measurement. Further, the effect of increase of the crystallomagnetic anisotropic energy which is obtained from single crystal of Sm₂Fe_{17.1}F_{0.1} by fluorine introduction is also confirmed. Besides the above described SmFeF system material, the materials in which any one of an increase of magnetization, a rise in the Curie temperature (Tc), and an increase in the crystallomagnetic anisotropic energy as above can be observed include Re₂Fe₁₇ (Re is shown as a rare-earth element including Y) system materials (Re₂Fe_{17.1}F_{0.1-3}), ReFe₁₂ system materials (ReFe₁₂F_{0.1-3}), ReFe₁₅₋₁₉ (ReFe₁₅₋₁₉F_{0.1-3}) system materials, and Re₃Fe₂₉ (Re₃Fe₂₉F_{0.1-3}) system materials such as CeFeF, PrFeF, NdFeF, PmFeF, EuFeF, GdFeF, TbFeF, DyFeF, HoFeF, ErFeF, TmFeF, YbFeF, LuFeF, and YFeF, and materials of the compositions in which some of Fe atoms in the above systems are replaced with transition metal elements including Co, Ti, Al, Mn, Mg, Si and Cu other than Fe, and the systems obtained by replacing some of the fluorine atoms with H, C, B, N, O and Cl.

### Example 24

SmFe₁₁Al particles of 100 g with a particle size of about 1 μm are mixed with ammonium fluoride (NHF₄) particles of 10 g, and after subjected to vacuum evacuation, the mixture is heated. CaH₂ is added thereto during heating, and oxidation progression on the SmFe₁₁Al particle surfaces is suppressed. The thermal treatment temperature is 300° C., and the holding time is 5 hours. After heating, the mixture is rapidly cooled, and the fluorinated SmFe₁₁Al particles are taken out of the heat treat furnace. By the present thermal treatment, a fluorine-containing reactive gas is generated from ammonium fluoride (NHF₄), and SmFe₁₁AlF_{0.1-3} particles can be produced. On the SmFe₁₁AlF_{0.1-3} particle surfaces, or the grain boundaries and the inside of the grains in the particles, fluorides, acid fluorides, oxides or hydrides such as SmF₃, SmOF, AlF₂, Al₂O₃, SmO₂, Fe₂O₃, Fe₃O₄ and SmH₂ grow.

It is confirmed that the crystal in which fluorine atoms are introduced grows in the body-centered tetragonal crystal (bct structure) of the matrix phase from the analysis of an X-ray diffraction pattern or a selected-area electron diffraction pattern by an electron microscope. The lattice volume of the body-centered tetragonal crystal is increased by introduction of fluorine. As the ferromagnetic phases other than the matrix phase, an iron-fluorine compound of a bcc or bct structure, or a ferrite having ferromagnetism also grows. The aforesaid bcc structure also includes a deformed bcc structure by lattice distortion and the like, and includes a bcc structure which has the lattice constants of the a-axis and the c-axis differ from each other by 0.01 to 1% and is difficult to determine as bct from a diffraction experiment. The fluorine concentration of the matrix phase is higher in the outer peripheral side than in the particle centers, and part of the particle surfaces is in contact with fluorides or acid fluorides containing fluorine in a higher concentration than the matrix phase. As a result of evaluating the magnetic properties about the particles before and after fluorination treatment, it is found out that the saturation magnetization increases by 15%, the Curie temperature rises by 200° C., and the uniaxial magnetic anisotropy energy (Ku) increases by 30%. The particles are loaded into a metal mold, is compression-molded by a load of 0.5 t/cm² at 500° C. after a magnetic field is applied thereto, and a molded body which is composed of SmFe₁₁AlF_{0.1-3} crystal grains and partially sintered is obtained. The magnetic properties of the molded body are a residual magnetic-flux density of 1.5 T, a coercive force of 31 kOe, and a Curie temperature of 795 K.

The magnet can be applied to an embedded magnet type motor and a surface magnet motor, and can be applied to a voice coil motor, a stepping motor, an AC servo motor, a linear motor, a power steering, an electric automobile drive motor, a spindle motor, an actuator, a synchrotron radiation undulator, a polarizing magnet, a fan motor, a permanent magnet type MRI, an electroencephalograph and the like. As materials which provide the effects of an increase of magnetization, a rise of the Curie temperature, and an increase of the magnetic anisotropy energy by fluorine introduction into the matrix phase as the present embodiment, besides SmFe₁₁Al particles, the materials using another transition elements such as Si, Ga, Ge and Ti as part or all of Al in place of Al, and the materials using an rare-earth element including Y or Mn for part or all of Sm in place of Sm are cited. Further, the fluorine introduction effect is also confirmed in fluorine compounds of SmFe_{11.1-30} which has a higher content of Fe than SmFe₁₁Al or fluorine compounds containing transition elements. The similar effect can be confirmed if the particle size of the SmFe₁₁Al particles is 20 μm or less, various gases containing fluorine can be used as the gas used for fluorination, and hydrides other than CaH₂ can be used as the reducer during heating.

### Example 25

SmFe₁₁Ti particles of 100 g with a particle size of about 0.5 μm are mixed with ammonium fluoride (NHF₄) particles of 10 g, and after subjected to vacuum evacuation, the mixture is heated. CaH₂ is added thereto during heating, and oxidation progression on the SmFe₁₁Ti particle surfaces is suppressed. The thermal treatment temperature is 200° C., and the holding time is 10 hours. After heating, the mixture is rapidly cooled, and the fluorinated SmFe₁₁Ti particles are taken out of the heat treat furnace. By the present thermal treatment, a fluorine-containing reactive gas is generated from ammonium fluoride (NHF₄), and SmFe₁₁TiF_{0.1-3} particles can be produced. SmFe₁₁TiF_{0.1-3} particles have the different fluorine concentrations in the center portions and the outer peripheral portions of the crystal grains or particles, and the fluorine concentration is higher in the outer peripheral portions than in the center portions. This is because fluorine diffuses from the outer peripheral portions. Even if the particles are of SmFe₁₁TiF_{0.1} in the center portions, the particles can be made of SmFe₁₁TiF₃ in the outer peripheral portions. If the holding time of the aforesaid thermal treatment is set as 20 hours, the fluorine concentration difference between the center portions and the outer peripheral sides becomes small, it is possible to make the center portions of SmFe₁₁TiF_{0.3} and the outer peripheral portions of SmFe₁₁TiF₃, and the fluorine concentration and the concentration gradient can be adjusted by the holding time, the gas partial pressure, gas species and the like in accordance with the targeted magnetic properties. On the SmFe₁₁TiF_{0.1-3} particle surfaces, or the grain boundaries and the inside of the grains in the particles, fluorides, acid fluorides, oxides or nitrides such as SmF₃, SmOF, TiF₂, Ti₂O₃, SmO₂, Fe₂O₃, Fe₃O₄ and TiN grow.

It is confirmed that the crystal in which fluorine atoms are introduced grows in the body-centered tetragonal crystal (bct structure) of the matrix phase from the X-ray diffraction pattern or the electron diffraction pattern. The lattice volume of the body-centered tetragonal crystal is increased by introduction of fluorine. As the ferromagnetic phases other than the matrix phase, an iron-fluorine binary alloy of a bcc or bct structure having a lattice distortion also grows. The fluorine concentration of the matrix phase is higher in the outer peripheral side than in the particle centers, and part of the particle surfaces is in contact with fluorides or acid fluorides containing fluorine in a higher concentration than the matrix phase. Therefore, in the crystal grain constituted by the matrix phase, the grain outer peripheral side, grain surface, or the vicinity of the interface which contains fluorine in a high concentration has the tendency to have a larger lattice volume and have larger anisotropy energy than the center portion of the grain. As a result of evaluating the magnetic properties about the particles before and after fluorination treatment, it is found out that the saturation magnetization increases by 35%, the Curie temperature rises by 250° C., and the uniaxial magnetic anisotropy energy (Ku) increases by 20%. The particles are loaded into a metal mold, is compression-molded by a load of 1 t/cm² at 400° C. after a magnetic field is applied thereto, and a molded body which is composed of SmFe₁₁AlF_{0.1-3} crystal grains and partially sintered is obtained. The magnetic properties of the molded body are a residual magnetic-flux density of 1.6 T, a coercive force of 35 kOe, and a Curie temperature of 835 K. For production of the molded body, various heating molding processes such as impact-compression molding, electrification molding, rapid-heating molding, heating molding by electromagnetic wave can be adopted besides the heating molding as described above. Further, as the fluorination treatment, CF type gas, HF type gas, or a solution containing fluorine can be used besides ammonium fluoride.

The magnet showing the above described magnetic properties can be applied to various motors such as a household electric/industrial magnet motor, a railway magnet motor, an electric automobile drive motor, and an HDD spindle/VCM motor, and magnetic circuits of medical equipment, measurement equipment and the like, and contributes to reduction in size and weight or enhancement in performance and efficiency of the magnetic circuits.

### Example 26

Iron particles with a particle size of 100 nm are produced by vacuum deposition. The iron particles produced in the deposition chamber are mixed with an alcohol solution in which a composition close to SmF₃ is swelled and Ti is added by 1 wt %, without being exposed to an atmosphere, and have an SmF₃ film of a thickness of 1 to 10 nm containing Ti formed on particle surfaces with a coverage factor of 90%. The fluoride-covered iron particles are heated and held at 500° C. with CaH₂, and thereafter, are cooled at an average cooling speed of 10° C./min or higher. After cooling, aging treatment is applied at 200° C. for 10 hours, and the iron particles are cooled at an average cooling speed of 20° C./min. As a result, Sm, Fe, F and Ti make diffusion reaction, and SmFe₁₁TiF_{0.01-2} of a tetragonal structure grows. Concentration gradients are seen in fluorine, Sm and Ti in the particles, the concentration gradient of fluorine is the largest, in the atomic concentration ratio with Sm as 1, the concentration of fluorine is 0.01 in the center portions, and 2 in the outer peripheral portions. By making the aging time longer, the concentration gradient shows the tendency to be smaller.

In the SmFe₁₁TiF_{0.01-2} particles which are produced as described above, fluorides such as SmF₃ and acid fluorides such as SmOF, which are not of tetragonal structures, oxides or carbides grow, the fluorides and acid fluorides have higher fluorine concentrations than SmFe₁₁TiF_{0.01-2}, but SmFe₁₁TiF_{0.01-2}, the interfaces with the SmFe₁₁TiF_{0.01-2}, and growth phases in the vicinity of the interfaces determine the magnetic properties, and some of the aforesaid fluorides such as SmF₃, acid fluorides such as SmOF, oxides and carbides form the interfaces having conformity with the crystal lattice of the matrix phase. In the SmFe₁₁TiF_{0.01-2} particles including the coated portion, SmFe₁₁TiF_{0.01-2} grows by 55% with respect to the entire volume, and when the portion substantially nonmagnetic with a small iron concentration out of the coated portions is removed, the particles show the magnetic properties of a saturation magnetic-flux density of 190 emu/g, a coercive force of 35 kOe and a Curie temperature of 825 K, and the surfaces or the crystal grain outer peripheral sides show the tendency to have larger magnetic anisotropy than the crystal grain centers. After the magnetic particles are mixed with a resin material, the mixture is magnetically oriented, and is compression-molded, whereby a bond magnet is produced. The volume of the magnetic particles account for 80% of the bond magnet, and the bond magnet with a residual magnetic flux density of 1.25 T and a coercive force of 34 kOe is obtained.

As a result of the bond magnet being applied to an embedded magnet motor, and an induced voltage waveform being measured after magnetization, an induced voltage higher than the other NdFeB system or SmFeN system rare-earth bond magnet is shown. As a result, ReₙFeₘFₗ (Re is an rare-earth element including Y, Fe is iron, F is fluorine, and n, m, and l are positive integers) or Reₙ(Fe, M)ₘFₗ to which another transition element (M) is added is magnetic materials in which the rare-earth contents are made smaller than the conventional bond magnet, and the magnetic properties are improved, and can be applied to various magnetic circuits. The magnet material which has a residual magnetic-flux density exceeding 1.2 T and a coercive force of 25 kOe or higher has the main phase expressed by Reₙ(Fe, M)ₘFₗ as described above, is accompanied by fluorides or acid fluorides necessary at the time of forming a fluorine compound of the main phase, and the concentration of the transition element M which is added is desirably lower than iron (Fe).

### Example 27

After an iron foil substance of a thickness of 2 μm is heated and reduced in a hydrogen atmosphere, and a surface oxide film is removed, the iron foil substance is mixed with an alcohol solution in which a composition close to SmF_{3.5} is swelled and 1 wt % of Mg is added without being exposed to an atmosphere, and an SmF_{3.1} film of a thickness of 1 to 10 nm containing Mg is formed on the particle surfaces with a coverage rate of 95%. The fluoride covered iron particles are heated and held at 400° C. with CaH₂, and thereafter, cooled at an average cooling speed of 20° C./min. After cooling, aging treatment is applied at 300° C. for 10 hours, and the iron particles are cooled at an average cooling speed of 30° C./min. As a result, Sm, Fe, F and Mg make diffusion reaction, and SmFe₁₁MgF_{0.1-4} of a tetragonal structure grows. Concentration gradients are seen in fluorine, Sm and Mg in the foil substance, the concentration gradient of fluorine is the largest, in the atomic concentration ratio with Sm as 1, the concentration of fluorine is 0.1 in the center portions, and 3 to 4 in the outer peripheral portions. By making the aging time longer, the concentration gradient shows the tendency to be smaller.

If the heating temperature is increased to a high temperature side such as 600° C. from 400° C., the contained fluorine concentration can be made high, but the fluorine atoms which do not penetrate between the lattices of the tetragonal crystal increase, and Sm₂Fe₁₇F₃, SmFe₅F₁₋₄ and the like also grow. In the SmFe₁₁MgF_{0.1-4} foil substance which is produced at a heating temperature of 400° C., fluorides such as SmF₃ and acid fluorides such as SmOF, oxides or carbides which are not of tetragonal structures, and iron of bcc and bct structures grow. The lattice volume of the iron of bcc and bct structures is smaller than the SmFe₁₁MgF_{0.1-4} lattice volume of the main phase. The fluorides and acid fluorides have higher fluorine concentrations than SmFe₁₁MgF_{0.1-4}, but SmFe₁₁MgF_{0.1-4}, the interfaces with the SmFe₁₁MgF_{0.1-4}, growth phases in the vicinity of the interfaces and iron of the bcc and bct structures determine the magnetic properties. In the SmFe₁₁MgF_{0.1-4} foil substance including the coated portions, SmFe₁₁MgF_{0.1-4} grows by 65% with respect to the entire volume, and when the portion substantially nonmagnetic with a small iron concentration out of the coated portions is removed, the foil substance shows the magnetic properties of a saturation magnetic-flux density of 200 emu/g, a coercive force of 30 kOe and a Curie temperature of 815 K.

### Example 28

Iron 50% manganese particles (Fe-50% Mn particles) with a particle size of 100 nm are prepared by vacuum deposition. The Fe-50% Mn particles produced in the deposition chamber are mixed with an alcohol solution in which a composition close to LaF₃ is swelled and Co is added by 1 wt %, without being exposed to an atmosphere, and have an LaF₃ film of a thickness of 1 to 10 nm containing Co formed on particle surfaces with a coverage factor of 90%. The fluoride-covered Fe-50% Mn particles are heated and held at 300° C. with CaH₂, and thereafter, are cooled at an average cooling speed of 10° C./min or higher. After cooling, aging treatment is applied at 200° C. for 10 hours, and the particles are cooled at an average cooling speed of 20° C./min. As a result, Mn, Fe, F and Co make diffusion reaction, and La(Fe, Co)₁₁MnF_{0.01-2} of a tetragonal structure grows. Concentration gradients are seen in fluorine, Mn and Co in the particles, the concentration gradient of fluorine is the largest, in the atomic concentration ratio with La as 1, the concentration of fluorine is 0.01 in the center portions, and 2 in the outer peripheral portions. By making the aging time longer, the concentration gradient shows the tendency to be smaller.

In the La(Fe, Co)₁₁MnF_{0.01-2} particles which are produced as described above, fluorides such as LaF₃ and acid fluorides such as LaOF, oxides, carbides and hydrides which are not of tetragonal structures grow, the fluorides and acid fluorides have higher fluorine concentrations than La(Fe, Co)₁₁MnF_{0.01-2}. La(Fe, Co)₁₁MnF_{0.01-2}, the interfaces with the La(Fe, Co)₁₁MnF_{0.01-2}, and growth phases in the vicinity of the interfaces determine the magnetic properties. In the La(Fe, Co)₁₁MnF_{0.01-2} particles including the coated portions, La(Fe, Co)₁₁MnF_{0.01-2} grows by 51% with respect to the entire volume, and LaMn₁₁F and La₂Mn₁₇F₂ further grow as ferromagnetic phases. The compounds composed of a rare-earth element, Mn and fluorine like this have most of the magnetic moment ferromagnetically coupled and have high magnetic anisotropy energy. When the portion which is substantially nonmagnetic out of the coated portions is removed, the particles show the magnetic properties of a saturation magnetic-flux density of 170 emu/g, a coercive force of 31 kOe and a Curie temperature of 754 K. After the magnetic particles are mixed with a nonmagnetic fluoride material, the mixture is magnetically oriented, and is compression-molded, whereby the fluorides are plastically deformed, and a bond magnet with high electric resistance with the fluorides as a binder can be produced. The volume of the magnetic particles accounts for 90% of the bond magnet with a fluoride binder (MgF₂), and the bond magnet with a residual magnetic-flux density of 1.21 T and a coercive force of 30 kOe is obtained. As a result of the bond magnet being applied to an embedded magnet motor, and an induced voltage waveform being measured after magnetization, an induced voltage higher than the other bond magnets constituted of main phases containing a rare-earth element such as NdFeB system or SmFeN system is shown.

As described above, Reₙ(Fe, M)ₘFₗ (n and m are positive integers, and l is a positive number) to which a transition element (M) is added is accompanied by growth of a ferromagnetic compound which is different from the main phase composed of elements M, Re and fluorine (F), and can be applied to various magnetic circuits as the magnet material in which the rare-earth content is made smaller than the conventional bond magnet and the magnetic properties are improved. The ferromagnetic compound different from the aforesaid main phase is a fluoride expressed by ReₓM_{y}F_{z} (Re is an rare-earth element, M is a transition metal element, F is fluorine, x, y and z are positive numbers, 0≦x<y, z<y), and part thereof has a matrix phase ferromagnetic coupling.

### Example 29

Iron, SmF₃ and Sm are mixed, and a target having a composition of Sm_{2.3}Fe₁₇F₄ is prepared. The target is placed in a sputtering device, and sputtering is applied to the surface of the target by Ar ions, whereby a thin film of SmFeF system is formed on a substrate. The composition of the film produced by sputtering is Sm₂Fe₁₇F₂. In order to form crystal grains constituted of a crystal structure of rhombohedral crystal or hexagonal crystal in the film, Ta is selected for a base material and the film is capped with Ta for oxidation prevention. After the sputtering film is heated to the temperature range of 200 to 300° C., and is held for 10 hours, growth of the crystal of the rhombohedral crystal can be confirmed from analysis of an X diffraction pattern or selected area electron diffraction image using an electron microscope, and it is confirmed that some of the fluorine atoms penetrate into 9e or 6h site of a Th₂Zn₁₇ structure and a Th₂Ni₁₇ structure. In order to increase the fluorine concentration of Sm₂Fe₁₇F₂, the aforesaid film formed on the substrate is thermally treated in a fluoride ammonium (NH₄F) decomposition gas. The thermal treatment temperature is 300° C. and the holding time is 1 hour. The composition of the thin film after thermal treatment changes to the composition of Sm₂Fe₁₇F₃ from Sm₂Fe₁₇F₂, and it is confirmed that the magnetic properties are improved with increase in the fluorine concentration. The magnetic properties of the Sm₂Fe₁₇F₃ film are a residual magnetic-flux density of 1.5 T, a coercive force of 35 kOe, and a Curie temperature of 770 K, and the Sm₂Fe₁₇F₃ film has the magnetic properties which can be applied to a magnetic recording medium. Growth of fluorides such as SmF₃, SmF₂, and FeF₂, acid fluorides such as SmOF, or iron oxides having structures different from the main phase is confirmed in the grain boundaries, interfaces or the like in the film from analysis of an electron diffraction image using an electron beam of a diameter of 2 nm.

The film with a residual magnetic-flux density exceeding 1.4 T and a Curie temperature exceeding 700 K as described above has the main phase having a crystal structure of a hexagonal crystal, a rhombohedral crystal, a tetragonal crystal, a rhombic crystal or the like shown by Reₙ(Fe, M)ₘFₗ (here, Re is a rare-earth element including Y, Fe is iron, M is a transition element, F is fluorine, and n, m and l are positive numbers) as described above, fluorides or acid fluorides which grow at the time of formation of the fluoride compound of the main phase is formed in the film, the concentration of the transition element M which is added contributes to enhancement of stability of the crystal structure, and is desirably smaller than iron (Fe) in order to ensure the residual magnetic-flux density, and even if the base layer and the capping layer are of a metal other than Ta, a fluoride, nitride, carbide, or oxide, substantially equivalent properties are obtained. There is no problem in properties even if the aforesaid Reₙ(Fe, M)ₘFₗ contains oxygen, hydrogen, nitrogen, carbon, boron or a trace quantity of metal as impurities.

### Example 30

Iron, SmF₃ and Sm are mixed, and two kinds of targets that are the target having a composition of Sm_{2.3}Fe₁₇F₅ and the target of Sm₂Fe₁₇ are prepared. The two targets are placed in a sputtering device, and sputtering is applied alternately to the surfaces of the two targets by Ar ions, whereby a thin film in which a thin film of an SmFeF system and a film of an SmFe system are stacked in layer is formed on a substrate. The film thickness of the SmFeF system thin film is 2 nm, and the film thickness of the SmFe system film is 3 nm. The multilayered film is thermally treated at 200° C., and optimization of the film forming conditions and the thermal treatment conditions is advanced so that the composition of the entire film is Sm₂Fe₁₇F₂. In order to form crystal grains constituted of a crystal structure of rhombohedral crystal or hexagonal crystal in the film, W (tungsten) is selected for a base material and the film is capped with W for oxidation prevention. Growth of the crystal of the rhombohedral crystal in the film after the thermal treatment can be confirmed from analysis of an X-ray diffraction pattern or the selected area electron diffraction image using an electron microscope. In order to increase the fluorine concentration of Sm₂Fe₁₇F₂, the aforesaid film surface formed on the substrate is further coated with an alcohol solution containing fluorides such as an SmF₃ film to grow the film, and the film is thermally treated. The thermal treatment temperature is 350° C. and the holding time is 1 hour. The composition of the thin film after thermal treatment changes to the composition of Sm₂Fe₁₇F_{2.5} from Sm₂Fe₁₇F₂, and it is confirmed that the magnetic properties are improved like increase of a coercive force, increase of a residual magnetic-flux density, increase of a saturation magnetic-flux density, decrease of a coercive force temperature coefficient, decrease of residual magnetic-flux density, rise in a Curie temperature and the like with increase in fluorine concentration. The magnetic properties of the Sm₂Fe₁₇F_{2.5} film are a residual magnetic-flux density of 1.45 T, a coercive force of 32 kOe, and a Curie temperature of 750 K, and the Sm₂Fe₁₇F_{2.5} film has the magnetic properties which can be applied to a magnetic recording medium. Growth of fluorides such as SmF₃, SmF₂, and FeF₂, acid fluorides such as SmOF, or iron oxides such as Fe₂O₃ and Fe₃O₄ having structures different from the main phase is confirmed in the grain boundaries, interfaces or the like in the film, from the analysis of an electron diffraction image using an electron beam of a diameter of 1 nm.

The film with a residual magnetic-flux density exceeding 1.4 T and a Curie temperature exceeding 700 K as described above has the main phase having a crystal structure of a hexagonal crystal, a rhombohedral crystal, a tetragonal crystal, a rhombic crystal, a cubic crystal or the like shown by Reₙ(Fe, M)ₘFₗ (here, Re is a rare-earth element including Y, Fe is iron, M is a transition element, F is fluorine, and n, m and l are positive numbers) as described above, fluorides, acid fluorides or oxides which grow at the time of formation of the fluoride compound of the main phase are formed in the film, the concentration of the transition element M which is added, such as Ti, Al, Ga, Ge, Bi, Ta, Cr, Mn, Zr, Mo, Hf, Cu, Pd, Mg, Si, Co, Ni and Nb contributes to enhancement of stability of the crystal structure, and is desirably smaller than iron (Fe) in order to ensure the residual magnetic-flux density, and even if the base layer and the capping layer are of a metal other than W, a fluoride, nitride, carbide, or oxide, substantially equivalent properties are obtained. There is no problem in properties even if the aforesaid Reₙ(Fe, M)ₘFₗ contains oxygen, hydrogen, nitrogen, carbon, boron or a trace quantity of metal as impurities, and chlorine may be used in place of fluorine of F.

### Example 31

A solution in which a composition close to SmF₃ is swelled with ethanol as a solvent, and a solution containing iron ions are used, and alternately coated on a substrate. The coating film thickness per one layer is 1 to 2 nm. The crystal structure of a single-layer film directly after coating is substantially amorphous. An iron plate is used for the substrate. The thickness of the entire film in which a layer with a larger amount of Sm and a layer with a larger amount of Fe are stacked is about 1 mm. The film is heated at 350° C. for 1 hour while a unidirectional magnetic field is being applied, and crystallized. Elements composing the amorphous structure diffuse by heating, cause phase transition to a metastable crystalline, and Sm₂Fe₁₇F₂ grows with fluorides and acid fluorides such as SmOF, Fe₂O₃, FeF₂ and FeF₃, oxides or carbides. In order to grow a large amount of Sm₂Fe₁₇F₂, a transition element such as Al, Ga, Ge, Co, Ti, Mg, Co, Mn, Nb, Cu, Bi, Pd and Pt which stabilizes Sm₂Fe₁₇F₂ is added to any one of the above described two kinds of solutions as an ion in the solvent by 0.01 to 1 wt %. The above described Sm₂Fe₁₇F₂ has a rhombohedral crystal Th₂Zn₁₇ or a hexagonal crystal Th₂Ni₁₇ structure, fluorine atoms are disposed in a 9e site of the rhombohedral crystal Th₂Zn₁₇, or a 6h site of the hexagonal crystal Th₂Ni₁₇ structure, either the a-axis length or the c-axis length is expanded by introduction of fluorine atoms, and increase in the lattice volume by 0.1 to 5%, or increase in lattice distortion by 0.1 to 15% by fluorine introduction can be confirmed. By increase in the lattice volume and the lattice distortion like this, any of increase in the magnetic moment, increase in the magneto crystalline anisotropy energy, rise in the Curie temperature (Curie point), and increase of exchange coupling energy of iron atoms can be observed. The Sm₂Fe₁₇F₂ film expresses anisotropy by an applied magnetic field, the magnetic properties thereof are a residual magnetic-flux density of 1.65 T, a coercive force of 32 kOe, and a Curie temperature of 780 K, and the Sm₂Fe₁₇F₂ film has the magnetic properties which can be applied to a magnetic recording medium, and a compact magnetic circuit including a motor.

The film with a residual magnetic-flux density exceeding 1.5 T and a Curie temperature exceeding 600 K as described above has the main phase having a crystal structure of a hexagonal crystal, a rhombohedral crystal, a tetragonal crystal, a rhombic crystal, a cubic crystal, a laves phase (Laves Phase) or the like shown by Reₙ(Fe, M)ₘFₗ (here, Re is a rare-earth element including Y, Fe is iron, M is a transition element, F is fluorine, and n, m and l are positive numbers) as described above, fluorides, acid fluorides or oxides which grow at the time of formation of the fluoride compound of the main phase are formed in the film, fluorine atoms which are disposed between iron-iron atoms and fluorine atoms which are not disposed between iron-iron atoms but form an compounds with a rare-earth element and oxygen are recognized, the concentration of the transition element M which is added, such as Ti, Al, Ga, Ge, Bi, Ta, Cr, Mn, Zr, Mo, Hf, Cu, Pd, Mg, Si, Co, Ni and Nb contributes to enhancement of stability of the crystal structure, and is desirably smaller than iron (Fe) in order to ensure the residual magnetic-flux density. There is no problem in properties even if the aforesaid Reₙ(Fe, M)ₘFₗ contains oxygen, hydrogen, nitrogen, carbon, boron or a trace quantity of metal as impurities or elements which are disposed in interstitial sites, and chlorine may be used in place of fluorine of F.

### Example 32

SmF₃ and Sm₂Fe₁₇ chips are disposed on an iron target, an Sm₂Fe₂₄F film is obtained by adjusting the number of chips. An Sm—Fe—F system film is formed with a thickness of 1 μm on a glass substrate by an Ar gas. During sputtering, a magnetic field is applied to the substrate, and magnetic anisotropy is added to the film. After the film is formed, the film is heated to 400° C. to diffuse, and a hard magnetic film is produced. In the film, a ferromagnetic phase with a crystal structure of a ThMn₁₂ type structure grows, and some of fluorine atoms are arranged in the interstitial sites. Further, by the above described heating treatment, fluorides and acid fluorides such as SmOF and Fe₂O₃, FeF₂ and FeF₃, oxides or carbides grow with a particle size of 1 to 100 nm in the film. In order to grow a large amount of Sm₂Fe₂₄F, a transition element such as Al, Ga, Ge, Co, Ti, Mg, Co, Mn, Cr, Nb, Cu, Bi, Pd, Pt, Bi, Sr, W, and Ca which stabilizes Sm₂Fe₂₄F is disposed as alloy chips with iron on the target, and is added to an Sm—Fe—F film in the range of 0.001 to 1 at %. The magnetic properties of the produced film are a residual magnetic-flux density of 1.6 T, a coercive force of 35 kOe, and a Curie temperature of 790 K, and the film has the magnetic properties which can be applied to a magnetic recording medium, a magnetic film of a magnetic head and a compact magnetic circuit including a motor.

The sputtering film with a residual magnetic-flux density exceeding 1.5 T and a Curie temperature exceeding 700 K as described above has the main phase having a crystal structure of a hexagonal crystal, a rhombohedral crystal, a tetragonal crystal, a rhombic crystal, a cubic crystal or the like shown by Reₙ(Fe, M)ₘFₗ (here, Re is a rare-earth element including Y, Fe is iron, M is a transition element, F is fluorine, and n, m and l are positive numbers) as described above, fluorides or acid fluorides which grow at the time of formation of the fluoride compound of the main phase, oxides and iron of a bcc or bct structure and an iron-fluorine binary alloy phase are formed in the film, fluorine atoms which are disposed between iron-iron atoms and fluorine atoms which are not disposed between iron-iron atoms but form an compounds with a rare-earth element and oxygen are recognized, and fluorine introduction effect is recognized in both of exchange coupling in a ferromagnetic substance and superexchange interaction in a ferrimagnetic substance. The concentration of the transition element M which is added, such as Al, Ga, Ge, Co, Ti, Mg, Co, Mn, Cr, Nb, Cu, Bi, Pd, Pt, Bi, Sr, W and Ca contributes to enhancement of stability of the crystal structure, and is desirably smaller than iron (Fe) in order to ensure the residual magnetic-flux density. There is no problem in properties even if the aforesaid Reₙ(Fe, M)ₘFₗ contains oxygen, hydrogen, nitrogen, carbon, boron or a trace quantity of metal impurities as impurities, and chlorine, phosphor, sulfur or a mixture of these elements and fluorine may be used in place of fluorine of F.

### Example 33

A solution in which a composition close to SmF₄ is swelled with ethanol as a solvent, and a solution containing iron ions are used, and alternately coated on a substrate. The coating film thickness per one layer is 10 to 20 nm. The crystal structure of a single-layer film directly after coating is substantially amorphous, and part of crystalline grows. A glass plate is used for the substrate. The thickness of the entire film in which a layer with a larger amount of Sm and fluorine and a layer with a larger amount of Fe are stacked is about 1 mm. The film is heated at 400° C. for 1 hour while a unidirectional magnetic field of 10 kOe is being applied, and amorphous or metastable phase is crystallized. Elements composing the metastable phase diffuse by heating, cause phase transition to a more stable crystalline, and Sm₂Fe₁₇F₃ grows with fluorides and acid fluorides such as SmOF, Fe₂O₃, FeF₂ and FeF₃, oxides or carbides. In order to grow a large amount of Sm₂Fe₁₇F₃, a transition element such as Ti, V, Co, Cr, Mn, Cu, Zn, Ga, Ge and As which stabilizes Sm₂Fe₁₇F₃ is added to any one of the above described two kinds of solutions as an ion in the solvent by 0.1 to 1 wt %. The above described Sm₂Fe₁₇F₃ has a rhombohedral crystal Th₂Zn₁₇ or a hexagonal crystal Th₂Ni₁₇ type structure, some of fluorine atoms are disposed in a 9e site of the rhombohedral crystal Th₂Zn₁₇, or a 6h site of the hexagonal crystal Th₂Ni₁₇ type structure, either the a-axis length or the c-axis length is expanded by introduction of fluorine atoms, and increase in the lattice volume by 0.1 to 7% by fluorine introduction can be confirmed. By increase in the lattice volume like this, the magnetic moment of iron atoms increases by 5 to 10% in average, the magneto crystalline anisotropy energy increases by about 50%, and the Curie temperature (Curie point) rises by 200° C. The Sm₂Fe₁₇F₃ film expresses anisotropy by an applied magnetic field, the magnetic properties thereof are a residual magnetic-flux density of 1.63 T, a coercive force of 35 kOe, and a Curie temperature of 795 K, at 298 K, and the Sm₂Fe₁₇F₃ film has the magnetic properties which can be applied to a magnetic recording medium, and a compact magnetic circuit including a motor.

The film produced by using the solution with a residual magnetic-flux density exceeding 1.5 T and a Curie temperature exceeding 750 K as described above has the main phase having a crystal structure of a hexagonal crystal, a rhombohedral crystal, a tetragonal crystal, a rhombic crystal, a cubic crystal, or the like shown by Reₙ(Fe, M)ₘFₗ (here, Re is a rare-earth element including Y, Fe is iron, M is a transition element, F is fluorine, n, m and l are positive numbers and n<l<m) as described above, fluorides, acid fluorides or oxides of a regular phase or an irregular phase which grow at the time of formation of the fluorine compound of the main phase are formed in the film, fluorine atoms which are disposed between iron-iron atoms and fluorine atoms which are not disposed between iron-iron atoms but form an compounds with a rare-earth element and oxygen, or disposition between rare-earth atoms and iron atoms are recognized, and in the interface of part of the main phase, it contributes to increase of coercive force that ferromagnetic coupling and superexchange interaction work. The concentration of the transition element M which is added, such as Ti, V, Co, Cr, Mn, Cu, Zn, Ga, Ge, and As contributes to enhancement of stability of the crystal structure, and is desirably smaller than iron (Fe) in order to ensure the residual magnetic-flux density. There is no problem in properties even if the aforesaid Reₙ(Fe, M)ₘFₗ contains oxygen, hydrogen, nitrogen, carbon, or a trace quantity of metal impurities as impurities, and chlorine, phosphor and sulfur may be used in place of fluorine of F.

### Example 34

A target in which SmF₃ and Sm₂Fe₁₇ chips are disposed on an iron target is placed in a sputter device. A mixture gas of Ar and fluorine is injected into the device, and reactive sputtering is tried. As a result, SmFe₂₄F₃ growing is confirmed, and growth of rhombic crystal and tetragonal crystal is confirmed, in an Sm—Fe—F film with a film thickness of about 1 μm subjected sputtering by unidirectionally applying a magnetic field of 30 kOe at a substrate temperature of 250° C. at a pressure of 1 mTorr by using an Ar-2% F₂ gas. Fluorides and acid fluorides such as SmOF, Sm(O, F, C), Fe₂O₃, FeF₂ and FeF₃, oxides, carbides or hydrides grow with a particle size of 0.1 to 100 nm in part of the grain boundaries and the grain surfaces. In order to grow a large amount of SmFe₂₄F₃, one or a plurality of transition elements such as Al, Ga, Ge, Co, Ti, Mg, Co, Mn, Cr, Nb, Cu, Bi, Pd, Pt, Sr, W, and Ca which stabilize SmFe₂₄F₃ are disposed as alloy chips with iron on the target, and are added to an Sm—Fe—F film in the range of 0.001 to 1 at %. The produced film is thermally treated at 300° C., whereby the crystal grains are grown and the average crystal grain size is made 10 to 100 nm. When thermal treatment is performed at a temperature higher than 500° C., the structure of SmFe₂₄F₃ changes, fluorides and acid fluorides in the vicinity of the grain boundaries grow, and the coercive force is reduced. By selection of the substrate material, a film in which the easy magnetization direction is oriented in the substrate face or the direction perpendicular to the substrate can be produced. The magnetic properties of SmFe₂₄F₃ are a residual magnetic-flux density of 1.7 T, a coercive force of 35 kOe, and a Curie temperature of 820 K, and the SmFe₂₄F₃ film has the magnetic properties which can be applied to a magnetic recording medium, a magnetic film of a magnetic memory such as MRAM and a magnetic head, and a compact magnetic circuit including a motor.

The sputtering film with a residual magnetic-flux density exceeding 1.6 T and a Curie temperature exceeding 700 K as described above is an Fe-rich compound or an alloy phase shown by Reₙ(Fe, M)ₘFₗ (here, Re is a rare-earth element including Y, Fe is iron, M is a transition element, F is fluorine, n, m and l are positive numbers, n<0.1 (n+m), Re content is less than 10 at % of the sum of Re, Fe and M) as described above, the aforesaid Fe-rich compound is a main phase with the alloy phase having a crystal structure of a hexagonal crystal, a rhombohedral crystal, a tetragonal crystal, a rhombic crystal, a cubic crystal or the like, and has different crystal structures depending on the fluorine concentration, fluorides or acid fluorides which grow at the time of formation of the fluoride compound of the main phase, oxides, iron of a bcc or bct structure and an iron-fluorine binary alloy phase are formed in the film, fluorine atoms which are disposed between iron-iron atoms and fluorine atoms which are not disposed between iron-iron atoms but form compounds with a rare-earth element and oxygen are recognized, and any one of fluorine introduction effects is recognized in both of exchange coupling in a ferromagnetic substance and superexchange interaction in a ferrimagnetic substance. Further, the concentration of the transition element M which is added, such as Al, Ga, Ge, Co, Ti, Mg, Co, Mn, Cr, Nb, Cu, Bi, Pd, Pt, Sr, W and Ca contributes to enhancement of stability of the crystal structure. There is no problem in properties even if the aforesaid Reₙ(Fe, M)ₘFₗ contains oxygen, hydrogen, nitrogen, carbon, boron or a trace quantity of metal impurities as impurities, and chlorine, phosphor, sulfur or a mixture of these elements and fluorine may be used in place of fluorine of F.

### Example 35

An iron-50% manganese alloy is used as a target, SmF₃ chips and SmMn chips are placed on the alloy target, and an alloy film of an SmFe₁₁Mn₅F₂ composition is formed at a gas pressure of 2 mTorr, and a sputtering speed of 0.1 μm/min by using an Ar gas. A magnetic field of 30 kOe is applied to the alloy film under vacuum of 1×10⁻⁶ Torr, the alloy film is held for 1 hour at 500° C., and is rapidly cooled to 20° C., and a magnetic field is also applied to the alloy film during cooling. In the film after rapid cooling, SmFe₁₁MnF and SmFeMn₁₁F₂ grow, and the composite magnetic materials with the former showing ferromagnetism, and the latter showing ferromagnetism are obtained. Other than two kinds of magnetic phases like this, fluorides and acid fluorides which differ in the lattice constant and the crystal structure from SmFe₁₁MnF and SmFeMn₁₁F₂, such as SmF₃, SmOF, MnF₂ and FeF₂ grow in the grain boundaries or the interfaces. Some of the fluorine atoms contained in SmFe₁₁MnF and SmFeMn₁₁F₂ are disposed in the interstitial sites, expand the crystal lattice, and in SmFe₁₁MnF, the magnetic moment increases, and the Curie temperature rises by about 250° C. by fluorine introduction. In SmFeMn₁₁F₂, the difference in the magnetic moment which depends on the atomic sites of Mn becomes large, and magnetization increases by 20%. The magnetic properties of the magnetic film of the SmFe₁₁Mn₅F₂ composition are high coercive properties of a residual magnetic-flux density of 1.3 T, and a coercive force of 35 kOe, with the demagnetization curve depending on the magnetic field direction during cooling, by expression of exchange coupling between the above described two phases by cooling in a magnetic field.

As the material which can satisfy the residual magnetic-flux density of 1.3 T and a coercive force of 25 kOe like this, the description can be made as follows. More specifically, the magnetic phase is composed of at least two phases of ReᵤFeᵥM_{w}Fₐ and ReₓFe_{y}M_{z}F_{b}, and under the conditions that Re is a rare-earth element including Y, Fe is iron, M is a transition metal element such as Mn and Cr, F is fluorine, u, v, w, a, x, y, z and b are positive numbers, and u<v, w<v, 0≦x<z, y<z and w<z, some of fluorine atoms are disposed in the interstitial sites in the lattice having iron or M atoms as main components, and magnetic coupling is present between at least two phases. Magnetic coupling can be confirmed by the fact that a difference of 0.5 kOe or more exists in the coercive force when the case of adoption of the aforesaid cooling in a magnetic field is compared with the case of non-magnetic field cooling, and the growth of the above described two phases is accompanied by growth of fluorides and acid fluorides in the grain boundaries or the grain surfaces, and the fluorine concentration is higher in the fluorides and acid fluorides in the grain boundaries than in the main phase. Magnetic coupling by introduction of fluorine like this also influences the other magnetic physical properties, therefore, can be applied to not only hard magnetic materials but also the refrigerants of magnetic refrigerators using magnetic specific heat, and magnetic power generation effective materials.

Even in the case of the main phase composed of only one phase of either ReᵤFeᵥM_{w}Fₐ or ReₓFe_{y}M_{z}F_{b} of the above described magnetic phase, the material shows hard magnetic properties, and can be applied to various magnetic circuits as a magnetic material. Further, as in the main phases, the electronic states change significantly by controlling u, v, w, a, x, y, z and b, a magnetic resistance effect, a magnetostriction effect, a thermoelectric effect, a magnetic refrigeration effect, a magnetic heat generation effect, a magnetic field induction structure phase transition or a superconductive property is shown.

### Example 36

An iron foil of a thickness of 2 μm is heated and reduced in a hydrogen gas, and oxides is removed from the surface. Fluorine ions are implanted in the iron foil at a temperature of 150° C. The implantation amount is 1×10¹⁶/cm². In the iron after implantation, a bcc structure or a bct structure with lattice constants of 0.2865 to 0.295 can be confirmed, and in the center portion or the inner portion of the foil substance, the fluorine concentration tends to be higher, and the lattice volume tends to be larger than in the outermost surface. By the implantation, the saturation magnetization of the iron foil increases by about 5%. Increase of the saturation magnetization is due to penetration of fluorine atoms to the tetrahedral sites or the octahedral sites of body-centered cubic lattices. After the fluorine-implanted iron foil is further coated with an alcohol solution in which an SmF₃ composition is swelled with a film thickness of 10 nm and is dried, the iron foil is thermally treated at 400° C. for 5 hours, and Sm and fluorine are diffused. Sm and fluorine diffuse to the iron foil center portion, and anisotropy increases. It is confirmed that in the iron foil, iron of bcc, iron of bct and Sm₂F₁₇F grow, and fluorine is disposed in the inter-lattice interstitial sites or replacement sites of iron and Sm₂Fe₁₇, as a result of which, the lattice distortion increases, and spacing of lattice planes increases, from the peak position and peak width of the X-ray diffraction pattern.

Further, it is confirmed that fluorides and acid fluorides grow in part of grain boundaries, with particle sizes smaller than the average particle size of the matrix phase from observation of an electronic microscope. The expansion amount of the lattice volume and the lattice volume of Sm₂Fe₁₇F by fluorine introduction are larger than those of the lattice of the aforesaid iron of bcc or bct. Increase in the magnetic moment of the iron atoms, increase in magnetic anisotropy energy, rise in the Curie temperature become obvious from magnetization measurement and measurement of the temperature dependence of magnetization with increase in the lattice volume. The iron foils with fluorine implantation like this, or with fluorine and nitrogen and fluorine and chlorine being implanted are stacked in layer, and the thickness thereof is adjusted to desired specifications, whereby the iron foil substance can be used in various magnetic circuits.

### Example 37

Sm₂Fe₁₇ particles are pulverized into a particle size of about 1 μm, and are reduced in a hydrogen current at 500° C. Pressure of 0.5 t/cm² is applied to the Sm₂Fe₁₇ particles from which oxides are removed in a magnetic field of 10 kOe, and a preform is produced. Gaps of the preform are impregnated with an alcohol solution in which an SmF_{3.1} composition is swelled. By the impregnation treatment, an SmF system amorphous film is formed on the Sm₂Fe₁₇ particle surfaces. The preform is heated and dried in a hydrogen current, and while oxidation is suppressed, part of the amorphous film is crystallized. Further, the preform is irradiated with an electromagnetic wave in the hydrogen current, and fluorides are caused to generate heat, whereby the Sm₂Fe₁₇ particle surfaces are fluorinated. A high-density molded body can be produced by application of pressure during fluorination. The magnetic properties are a residual magnetic-flux density of 1.6 T, a coercive force of 25 kOe, and a Curie temperature of 720 K, and the molded body has the magnetic properties which can be applied to a magnetic recording medium, a magnetic film of a magnetic head, and a compact magnetic circuit including a motor.

The molded body with a residual magnetic-flux density of 1.6 T and a Curie temperature exceeding 700 K as described above is an Fe-rich compound or an alloy phase shown by Reₙ(Fe, M)ₘFₗ (here, Re is a rare-earth element including Y, Fe is iron, M is a transition element, F is fluorine, n, m and l are positive numbers, n<0.11 (n+m), the Re content is less than 11 at % when the sum of Re, Fe and M is set as 100%) as described above, the aforesaid Fe-rich compound is a main phase with the alloy phase having a crystal structure of a hexagonal crystal, a rhombohedral crystal, a tetragonal crystal, a rhombic crystal, a cubic crystal or the like, and has different crystal structures depending on the fluorine concentration, fluorides or acid fluorides which grow at the time of formation of the fluoride compound of the main phase, oxides, iron of a bcc structure or bct structure and an iron-fluorine binary alloy phase are formed in the molded body, fluorine atoms which are disposed between iron-iron atoms and fluorine atoms which are not disposed between iron-iron atoms but form compounds with a rare-earth element and oxygen are recognized, and any of the fluorine introduction effects is recognized in both of exchange coupling in a ferromagnetic substance and superexchange interaction in a ferrimagnetic substance. The fluorine concentration tends to be higher in the grain outer peripheral sides in average than in the grain centers, and the lattice volume tends to be larger in the outer peripheral sides of the grains than in the center portions. Magnetic anisotropy is large in the grain outer peripheral sides, and therefore, the difference is found in the magnetic wall width of the magnetic domain structure. When the fluorides of the main phase is heated to 600° C. or higher, some of the crystal grains change in structure to be more stable fluorides and iron alloy phase.

In order to suppress the structure change as above, use of additive elements is effective. The concentration of the transition element M which can be added, such as Al, Ga, Ge, Co, Ti, Mg, Co, Mn, Cr, Nb, Cu, Pd, Pt, Bi, Sr, W and Ca contributes to enhancement of stability of the crystal structure. There is no problem in properties even if the aforesaid Reₙ(Fe, M)ₘFₗ contains oxygen, hydrogen, nitrogen, carbon, boron or a trace quantity of metal impurities as impurities, some of M and Re elements are unevenly distributed in the grain boundaries and the grain surfaces, and chlorine, phosphor, sulfur or a mixture of these elements and fluorine may be used in place of fluorine of F. Further, in the Co-rich compound or alloy phase expressed by Reₙ(Co, M)ₘFₗ (here, Re is a rare-earth element including Y, Co is cobalt, M is one or more transition elements, F is fluorine, n, m and l are positive numbers, n<0.11 (n+m), the Re content is less than 11 at % when the sum of Re, Co and M is 100%) for which Co is used in place of iron used in the above described ferromagnetic fluoride, any of the effects of increase in coercive force, increase in magnetization and rise in the Curie temperature by fluorine introduction can be obtained.

### Example 38

Sm₂Fe₁₇ particles are pulverized into a particle size of about 0.5 and are reduced in an ammonia current at 500° C. Pressure of 0.5 t/cm² is applied to the Sm₂Fe₁₇ particles in which oxides are removed and part of the surfaces is nitrided in a magnetic field of 10 kOe, and a preform is produced. Gaps of the preform are impregnated with an alcohol solution in which a PrF_{3.1} composition is swelled. By the impregnation treatment, a PrF system amorphous film is formed on the Sm₂Fe₁₇N₁₋₃ particle surfaces. The preform is heated and dried in a hydrogen current, and while oxidation is suppressed, part of the amorphous film is crystallized. Further, the preform is irradiated with an electromagnetic wave in the hydrogen current, and fluorides are caused to generate heat, whereby the Sm₂Fe₁₇ particle surfaces are fluorinated. A high-density molded body can be produced by application of pressure during fluorination, and exchange reaction of Pr and Sm partly advances by diffusion. PrF₃, PrOF and Pr₂O₃ grow on the magnetic particle surfaces, and (Sm, Pr)₂Fe₁₇(N, F)₁₋₃ grows on the outer peripheral portions of crystal grains in the magnetic particles. The fluorine concentration and Pr concentration are lower in the crystal grain center portions than in the outer peripheral portions, the lattice constant is smaller in the crystal grain center portions than in the outer peripheral portions, and single cell or lattice volume tends to be smaller in the inner peripheral portions than in the outer peripheral portions of the crystal grains in average. In some of the crystal grain boundaries or surfaces, phases containing Fe of a bcc, bct or fcc structure, Fe—F, or a trace amount of rare-earth element, nitrogen, carbon, oxygen and the like in these iron-based alloys grow besides the above described fluorides, acid fluorides and oxides containing a rare-earth element. The lattice constant of these Fe-based alloy is smaller than (Sm, Pr)₂Fe₁₇(N, F)₁₋₃ of the aforesaid matrix phase, and the lattice volume is smaller in the Fe-based alloy than the matrix phase.

The magnetic properties of the magnetic particles are a residual magnetic-flux density of 190 emu/g, a coercive force of 25 kOe, and a Curie temperature of 730 K, and the magnetic particles have the magnetic properties which can be applied to a compact magnetic circuit including a motor, and therefore can be applied to magnet motors such as a surface magnet motor, an embedded magnet motor, a polar anisotropy magnet motor, a radial ring magnet motor, an axial gap magnet motor, and a linear magnet motor. The magnetic particles with a residual magnetic-flux density of 190 emu/g and a Curie temperature exceeding 700 K as described above are an Fe-rich compound or an alloy phase expressed by Reₙ(Fe, M)ₘ(N, F)ₗ (here, Re is a rare-earth element including Y, Fe is iron, M is a transition element, N is nitrogen, F is fluorine, n, m and l are positive numbers, n<0.11 (n+m), the Re content is less than 11 at % when the sum of Re, Fe and M is set as 100%) as described above, the aforesaid Fe-rich compound is a main phase with the alloy phase having a crystal structure of a hexagonal crystal, a rhombohedral crystal, a tetragonal crystal, a rhombic crystal, a cubic crystal or the like, and has different crystal structures and regular/irregular structures depending on the fluorine concentration, fluorides or acid fluorides which grow at the time of formation of the fluoride compound of the main phase, oxides, iron of a bcc, bct or fcc structure and an iron-fluorine binary alloy phase are formed in the molded body, fluorine atoms which are disposed between iron-iron atoms and fluorine atoms which are not disposed between iron-iron atoms but form compounds with a rare-earth element and oxygen are recognized, and a fluorine introduction effect is recognized in exchange coupling by distribution change of the electronic state density in the ferromagnetic substance. The fluorine concentration tends to be higher in the grain outer peripheral sides in average than in the grain centers, and the lattice volume tends to be larger in the outer peripheral sides of the grains than in the center portions. When n≧0.01 is satisfied, the rare-earth concentration becomes high, the raw material cost of the material becomes high, and the residual magnetic-flux density reduces. The optimal n satisfies 0.01<n<0.11. In the case of n≦0.01, the coercive force decreases, and the residual magnetic-flux density also reduces. In this material, the magnetic anisotropy is large in the grain outer peripheral sides, and therefore, the difference is found in the magnetic wall width of the magnetic domain structure. When the nitrogen-containing fluorides of the main phase is heated to 600° C. or higher, some of the crystal grains change in structure to be more stable fluorides, nitrides and iron alloy phase.

In order to suppress the structure change as above, use of additive elements is effective. The concentration of the transition element M which can be added, such as Al, Ga, Ge, Co, Ti, Mg, Co, Mn, Cr, Nb, Cu, Bi, Sr, W and Ca contributes to enhancement of stability of the crystal structure. There is no problem in properties even if the aforesaid Reₙ(Fe, M)ₘ(N, F)ₗ contains oxygen, hydrogen, carbon, boron or a trace quantity of metal impurities as impurities, and some of M elements are unevenly distributed in the grain boundaries and the grain surfaces. Chlorine, phosphor, sulfur or a mixture of these elements and fluorine may be used in place of fluorine of F.

### Example 39

Sm_{2.1}Fe₁₇ alloy is prepared by vacuum fusion, and is pulverized by hydrogen, and thereby, Sm₂Fe₁₇ particles with a particle size of about 10 μm are obtained. The particles are heated to 300° C. in a gas obtained by decomposition of CaH₂ and NH₄F, and are held for 5 hours. By the thermal treatment, Sm₂Fe₁₇F_{0.1-3} grows. The Sm₂Fe₁₇F_{0.1-3} is loaded into a metal mold of the heat-molding device, and is extruded by a load of 3 t/cm² at 400° C. The particles are plastically deformed during heat molding, whereby the orientation direction of Sm₂Fe₁₇F_{0.1-3} becomes uniform, and a magnetic substance or magnetic particles with high anisotropy are obtained. Sm₂Fe₁₇F_{0.1-3} can be grown from the Sm_{2.1}Fe₁₇ surface by mechanical alloying by using a mixture slurry of the particles of SmF₃ with an average particle size of 10 nm and alcohol, in place of heating in the gas obtained by decomposition of CaH₂ and NH₄F. As a result of mixing anisotropic magnetic particles with an organic resin material and being thermal-compression molded in the magnetic field, a compression-molded bond magnet with 20 volume % of resin, a residual magnetic-flux density of 1.3 T, and a coercive force of 25 kOe can be obtained. In the bond magnet like this, the volume of the binder material can be further reduced by using fluorides such as MgF₂ which is an inorganic binder instead of the resin binder, and the residual magnetic-flux density and energy product are increased.

The main phase composition of the magnetic particles which satisfies the magnetic properties of the aforesaid bond magnet is RexFeyFz (Re is a rare-earth element including Y, Fe is iron, F is fluorine, x, y and z are positive numbers and y>(x+z)), some of fluorine atoms are disposed in the interstitial sites of the main phase, fluorine-containing iron of a bcc structure or a bc, t structure, acid fluorides such as SmOF, and fluorides such as SmF₃ and FeF₂, nonmagnetic or ferrimagnetic oxides such as Fe₂O₃ and SmO₂, or hydrides grow in some of the grain boundaries or the grain surfaces, the fluorine concentration is the highest in the aforesaid acid fluorides or fluorides, the lattice volume of the main phase is larger than the iron-fluorine alloy of bcc or bct, the crystal grains or magnetic particles composing the magnet have orientation in the a-axis or c-axis direction, and the volume of the aforesaid main phase is 30% or more and desirably 50% to 90% of the entire bond magnet, whereby a high residual magnetic-flux density can be realized, and various gases containing fluorine besides ammonium fluoride can be used at the time of fluorination. The main phase composing the magnetic particles for the aforesaid bond magnet may have RexMyFz (Re is a rare-earth element including Y, M is Co or an alloy of Fe and Co, F is fluorine, a mixture of fluorine with carbon, nitrogen, oxygen, boron, chlorine, phosphor, sulfur or hydrogen, or chlorine, x, y and z are positive numbers, y>(x+z)) besides the basic composition of RexFeyFz.

### Example 40

A sintered magnet with Nd₂Fe₁₄B as a main phase is pulverized, and magnetic particles with a particle size of 3 to 10 μm are produced, and is mixed with a slurry in which FeF₂ particles with an average particle size of 0.5 μm are mixed with alcohol, and mechanical alloying is carried out by stainless steel balls coated with a fluoride. After mechanical alloying, some of the surfaces of the Nd₂Fe₁₄B particles are fluorinated, an Nd₂Fe₁₇F phase and iron of bcc or bct further grow by thermal treatment at 300° C., the Curie temperature rises more than directly after mechanical alloying, and the residual magnetic-flux density increases. Increase of the magnetic-flux density is due to growth of the Nd₂Fe₁₇F phase having a high Curie point with iron by the above described mechanical alloying (mechanical alloying) and the subsequent thermal treatment.

Besides the ferromagnetic phase as above, fluorides such as FeF₃, NdF₃ and NdF₂, acid fluorides such as NdOF and (Nd, Fe)OF, or oxides such as Nd₂O₃, Fe₂O₃ and Fe₃O₄ grows in the surfaces of the particles. The ferromagnetic phases are of Nd₂Fe₁₄B, Nd₂Fe₁₇Fx (x=0.01 to 2) and iron, ferromagnetic coupling works among some of the ferromagnetic phases, and increases the residual magnetic-flux density. The fluorine concentration of Nd₂Fe₁₇F is increased by exposing the particles to a gas containing fluorine such as ammonium fluoride, fluorine, and hydrogen fluoride at the time of heat treatment after mechanical alloying, Nd₂Fe₁₇F₂₋₃ grows on the particle surfaces, and the Curie temperature rises to 710 K. By growing a hard magnetic phase having a higher Curie temperature and larger magnetic anisotropy than Nd₂Fe₁₄B by being magnetically coupled with Nd₂Fe₁₄B, contribution can be made to suppression of inversion of magnetization and reduction of thermal demagnetization of Nd₂Fe₁₄B, heat resistance can be enhanced without addition of a heavy rare-earth element. The particle centers are of an iron-rich phase with soft magnetic properties, a hard magnetic material having high magnetic anisotropy and a high Curie temperature is grown in the outer peripheral side of the iron-rich phase, and magnetic coupling is added between the iron-rich phase and the hard magnetic material, whereby the hard magnetic material with which the use amount of the rare-earth element can be reduced can be produced. More specifically, light rare-earth fluorides are grown on the surfaces of iron-fluorine alloy particles containing fluorine and showing a magnetic-flux density higher than pure iron by solution treatment, fluorine and light rare-earth elements are diffused by thermal treatment in a hydrogen or fluorine-containing gas, and RexFeyFz (Re is a light rare-earth element, Fe is iron, F is fluorine, x, y and z are positive numbers, y>(x+z)) and acid fluorides can be grown in the outer peripheral sides of the particles, whereby a magnet material with a residual magnetic-flux density of 1.8 T can be obtained.

As in the present example, the magnetic properties can be improved by adding ferromagnetic coupling to between a plurality of ferromagnetic phases having different crystal structures and compositions, at least one ferromagnetic phase contains fluorine, the fluorine concentration has a concentration gradient in the crystal grains, some of fluorine atoms form compounds with a rare-earth element and iron, some of fluorine atoms are disposed in iron, due to a high electronegativity of fluorine, deviations occur to the electron state density distribution and electric field gradient, the physical values of the magnetic properties and the electric properties change, the magnetic properties are improved, and the residual magnetic-flux density of 1.8 T is realized. In response to the change of the magnetic physical properties like this, the fluorine introduction effect appears in the magnetic transformation in the internal magnetic field at a low temperature, magnetic resistance effect, magnetic heat generation effect, magnetic heat absorption effect and superconductivity.

### Example 41

An alloy target of Sm₂Fe₁₇ with purity of 99.9% is prepared, one surface of the target is cooled by water, and sputtering is applied on one side. At the time of sputtering, a film is formed on an MgO (100) substrate with a substrate temperature of 250° C. at a speed of 10 nm/min with gas pressure of 1 mTorr during sputtering with ultimate vacuum of 1×10⁻⁵ Torr by using an Ar-2% SF₆-1% F₂ gas. The substrate surface is cleaned by cleaning and reverse sputtering before sputtering. The produced film composition is Sm₂Fe₁₇F₂, and has the lattice constant increased from that of the Sm₂Fe₁₇ film, and increase of the Curie temperature, the saturation magnetic-flux density and magnetic anisotropy energy is seen. Further, the orientation of the Sm₂Fe₁₇F₂ film depends on the substrate temperature and the film formation speed, in the above described conditions, the film with c-axis orientation is obtained, and the film has an axis of easy magnetization in the plane thereof. Sm₂Fe₁₇F₂ epitaxially grows on the MgO substrate. It is confirmed that when the film is heated at 400° C. for 1 hour, iron of a bcc or bct structure containing SmF₃ and fluorine grows from an XRD pattern. The above described iron of a bcc or bct structure containing fluorine has saturation magnetization higher by 1 to 20% than saturation magnetization of pure iron, and therefore, the residual magnetic-flux density can be made high by giving ferromagnetic coupling between the fluorine-containing ferromagnetic iron and the fluorine compound which is the main phase.

The fluorine-containing iron as above has a metastable phase, and changes to FeF₂ when heated, and for the purpose of stabilizing the metastable phase up to a high temperature, the effective means are stabilizing the structure by being brought into contact with acid fluorides having lattice constants of 5.4 to 5.9 nm, stabilizing the structure by adding carbon and nitrogen, growing the iron with bcc and the like. By these means, fluorine-containing iron hardly causes structural change at 400° C. The Sm₂Fe₁₇F₂ film which grows on the above described MgO substrate is thermally treated at 400° C. for 1 hour, and has the magnetic properties of a residual magnetic-flux density of 1.55 T, and a coercive force of 26 kOe. Sm₂Fe₁₇F_{2.5} is formed by increasing the gas pressure during sputtering, and thermally treated at 450° C., whereby the film with an average particle size of 50 nm can be formed, fluorides and iron of a bcc and a bct structures grow in some of the grain boundaries, and a high coercive force film with a residual magnetic-flux density of 1.60 T and a coercive force of 31 kOe is obtained.

The material with a residual magnetic-flux density of 1.4 T or higher and a coercive force exceeding 20 kOe like this is confirmed in the following similar materials besides the above described Sm₂Fe₁₇F₂. More specifically, the above described magnetic properties can be realized by the material in which the ferromagnetic phase of the main phase has one or more composition expressed by RexFeyFz (Re is a rare-earth element including Y, Fe is iron, F is fluorine, x, y and z are positive numbers and y>(x+z)), and is formed into magnetic particles or crystal grains, some of the fluorine atoms are disposed in the interstitial sites of the main phase, fluorine-containing iron of a bcc or bct structure, acid fluorides such as SmOF, and fluorides such as SmF₃ and FeF₂, or nonmagnetic oxides such as Fe₂O₃ and SmO₂, or ferrimagnetic or antiferromagnetic oxides grow in some of the grain boundaries or the grain surfaces, the fluorine concentration is the highest in the aforesaid acid fluorides or fluorides, the lattice volume of the main phase is larger than an iron-fluorine alloy of bcc and bct, and the crystal grain or magnetic particles composing the magnet have orientation in the a-axis or c-axis direction. F may be fluorine or mixture of fluorine and carbon, nitrogen, oxygen, boron, chlorine, phosphor, sulfur, or hydrogen, or chlorine in place of fluorine, and various gas species containing fluorine and chlorine can be used.

The above description is made on the examples, but the present invention is not limited to the description, and it is obvious to a person skilled in the art to be able to make various changes and corrections within the range of the spirit and the accompanying claims of the present invention.

### REFERENCE SIGNS LIST

2 STATOR
4 TEETH
5 CORE BACK
7 COIL INSERTION POSITION
8 COIL
9 TIP END PORTION
10 ROTOR INSERTION PORTION
100 ROTOR

1. A magnetic material, comprising two kinds of ferromagnetic phases that are a ferromagnetic compound containing three elements of fluorine, iron and one of rare-earth elements including yttrium, and ferromagnetic iron in which fluorine penetrates into a position in a lattice of iron, wherein
a fluoride and/or an acid fluoride are formed at a part of a grain boundary or a surface of the ferromagnetic phases,
the ferromagnetic iron has a bcc structure or a bct structure, and
the ferromagnetic iron contains fluorine or carbon.

2. A magnetic material, comprising a ferromagnetic phase having at least two kinds of phases of a ferromagnetic compound and ferromagnetic iron in which fluorine penetrates into a position in a lattice of iron, expressed by the following expression,
A{Reₗ(Fe_{q}Mᵣ)ₘIₙ}+B{FeₓI_{y}}
(where A is a volume fraction of a phase composed of Re, Fe and I with respect to entire particles, an entire bulk sintered body or an entire thin film,
B is a volume fraction of a phase composed of Fe and I with respect to entire particles, an entire bulk sintered body or an entire thin film,
Re is one of rare-earth elements including yttrium
Fe is iron
M is a transition metal element other than iron
I is any of fluorine and nitrogen; and fluorine and carbon,
A≧0.5 (50% or more of the magnetic material)
A>B>0,
l, m, n, q, r, x and y are positive integers, and
m>n, m>l, x>y, and q>r≧0),
wherein a fluoride or an acid fluoride is formed at a part of a grain boundary or a surface of the ferromagnetic phase,
a fluorine concentration of the fluoride or the acid fluoride is higher than a fluorine concentration of the ferromagnetic phase, and
the ferromagnetic iron has a bcc structure or a bct structure.

3. The magnetic material according to claim 1, wherein a part of the elements included in the ferromagnetic iron is arranged in an interstitial site of a lattice of the ferromagnetic compound.

4. The magnetic material according to claim 1, wherein a fluorine atom concentration near the grain boundary or the surface of the ferromagnetic phases differs from a fluorine atom concentration of the interior of a crystal grain of the ferromagnetic phases.

5. The magnetic material according to claim 1, wherein a lattice constant near the grain boundary or the surface of the ferromagnetic phases differs from a lattice constant of the interior of a crystal grain of the ferromagnetic phases.

6. The magnetic material according to claim 1, wherein a concentration at an interstitial site concerning a predetermined element present near the grain boundary or the surface of the ferromagnetic phases differs from a concentration of the interior of a crystal grain of the ferromagnetic phases.

7. The magnetic material according to claim 1, wherein the ferromagnetic iron is an iron-fluorine binary alloy, and the iron-fluorine binary alloy has a plurality of crystal structures.

8. The magnetic material according to claim 1, wherein the ferromagnetic iron is an iron-fluorine compound of a body-centered tetragonal crystal, and a lattice constant of the body-centered tetragonal crystal is 0.57 nm to 0.65 nm.

9. The magnetic material according to claim 1, wherein the ferromagnetic iron is an iron-fluorine compound of a body-centered tetragonal crystal, and iron and fluorine atoms are regularly arranged.

10. The magnetic material according to claim 1, wherein the ferromagnetic iron is an iron-fluorine compound of a body-centered tetragonal crystal, and a lattice volume of the ferromagnetic compound is larger than a lattice volume of the ferromagnetic iron.

11. A motor using the magnetic material according to claim 1 in a rotor.
